(19) United States
(12) Patent Application Publication
(10) Pub. No.: US 2026/0220661 A1
(43) Pub. Date: Jul. 30, 2026

(54) Subject Line Variation Generator for AB Testing in Digital Communication Management

(71) Applicant: Klaviyo, Inc., Boston, MA (US)

(72) Inventors: Justin Xu, Mountain View, CA (US); Jack Cosgrove, Boston, MA (US); Nicholas Vessella, Boston, MA (US); Carola Leiva, Boston, MA (US); Nikhil Bhaip, Medford, MA (US); Karl Alexander Philip Ekfeldt, London (GB)

(21) Appl. No.: 19/041,685

(22) Filed: Jan. 30, 2025

(51) Int. Cl. G06Q 30/0242; G06Q 30/0251

(52) U.S. Cl. CPC G06Q 30/0244; G06Q 30/0271

(57) ABSTRACT

An AB testing method for digital communication management comprising: receiving by a front-end server a user-supplied subject line; receiving from the user a plurality of dimensions for varying a characteristic of the subject line; sending the user-supplied subject line and the user-selected dimension to a subject line variation generator; and applying, by the subject line variation generator, a logic rule to the subject line based on the user-selected dimension. The logic rules query whether the user-supplied subject line is characterized by the user-selected dimension; and generate a dimension-customized LLM prompt. The LLM is trained to return candidate subject line variations based on the user-supplied information and custom prompts supplied in a call to the LLM. The method further comprises selecting a subject line variation, optionally the first variation; and displaying the subject line variation to the user. An AB test manager server is operable to create and run the AB test based on the user-supplied subject line, the generated subject line variation, and a set of testing default parameters. Optionally, an ESP is operable to generate bulk electronic messages comprising the AB test winner, and send the bulk electronic messages to the recipients.

### FIELD OF THE DESCRIBED EMBODIMENTS

The described embodiments relate generally to electronic messages used in digital communications. More particularly, the described embodiments relate to methods and systems for automatic generation of subject line variations for AB testing.

### BACKGROUND

Electronic messages are frequently sent in bulk from electronic messaging platforms to recipient computing devices over the internet. For example, electronic messages are frequently sent from online merchant users to current and prospective customers to generate sales of the merchant's products or services. The subject lines of the electronic messages can influence the success of the electronic messages. To this end, optimized subject lines are desired.

Previous attempts to anticipate open rates for a subject line are described in Paulo et al., Leveraging email marketing: Using the subject line to anticipate the open rate, Expert Systems with Applications, Volume 207, 2022, 117974. However, such techniques tend to base the prediction on only the features of the current subject line when trying to predict its performance. Consequently, the same subject line will receive the same score whether Company A sends it or Company B sends it. For example, Company A may have a more playful brand whereas Company B could have a more serious brand. It follows that a subject line with lots of exclamation points and emojis would be recommended to both Company A and Company B, even if Company B may see only limited success with using such a subject line because the Company B brand is of a more serious nature.

As companies develop a unique brand voice they will engage with their audiences in different ways. A one-size fits all approach—even if sending the best electronic message overall—can still be problematic for sending electronic messages from different companies.

Another challenge is testing subject lines. An AB test, for example, can include the creation of an “all things being equal” experiment, with one single difference that is hypothesized to generate better performance. The problem, however, is to create an AB test, users need relatively extensive knowledge of experimentation and time. Users need to develop a hypothesis, define the type of test to run, and create multiple variations. Creating multiple variations is one of the hardest parts of running an AB experiment, as users typically struggle to create even a single good version of their communication.

Additionally, historically, creating the AB test even for sophisticated users, takes a lot of time, prone to errors, and is highly manually driven.

It is therefore desirable to have methods, apparatuses, and systems for automatic generation of the subject lines that address the above mentioned challenges.

### SUMMARY

An embodiment of the invention is a computer-implemented method for generating subject line variations for AB testing for electronic messages in digital communication management.

In embodiments of the invention, a computer-implemented method of generating subject line variations for AB testing for digital communication management comprises: receiving, on a first server, a user-supplied subject line via a GUI; presenting to the user via the GUI a plurality of dimensions for varying a characteristic of the subject line; receiving, on the first server, a user-selected dimension from the plurality of dimensions; sending the user-supplied subject line and the user-selected dimension to a subject line variation generator; applying, by the subject line variation generator, a logic rule to the subject line based on the user-selected dimension wherein the logic rule comprises: querying whether the user-supplied subject line is characterized by the user-selected dimension; and generating a dimension-customized LLM prompt based on whether the user-supplied subject line is characterized by the user-selected dimension.

In embodiments of the invention the method further comprises sending, to an LLM, the user-supplied subject line and the dimension-customized LLM prompt; receiving from the LLM at least one subject line variation; choosing the subject line variation; and displaying the subject line variation to the user.

In embodiments of the invention, the method further comprises applying, between the steps of receiving the at least one subject line variation and prior to the choosing step, a first post-processing filter operable to determine the number of characters in each of the subject line variations and to remove subject line variations that have a character count exceeding a maximum threshold.

In embodiments of the invention, the method further comprises applying, between the steps of receiving the at least one subject line variation and prior to the choosing step, a second post-processing filter operable to search for offending terms and to remove subject line variations that have said offending terms, wherein the offending terms are predetermined and stored in an electronic file.

In embodiments of the invention, the user selected dimension is to vary the subject line by personalization, and the querying step is performed by evaluating the type of tag assigned to the user-supplied subject line when the user-supplied subject line was created.

In embodiments of the invention, the user selected dimension is to vary the subject line by emojis, and the querying step is performed by evaluating the user-supplied subject line for the presence of emojis.

In embodiments of the invention, the user selected dimension is to vary the subject line between a statement and a question, and the querying step is performed by evaluating the user-supplied subject line for punctuation.

In embodiments of the invention, the user selected dimension is to vary the subject line length, and the querying step is performed by evaluating the user-supplied subject line by the number of characters.

In embodiments of the invention, the method further comprises creating and running the AB test between the user-supplied subject line, the chosen subject line variation, and a set of default test parameters, optionally test duration and test size.

In embodiments of the invention, the AB test comprises tracking recipient actions, optionally, average open rate, average click rate, or product ordered.

In embodiments of the invention, the method further comprises generating an email comprising a winning subject line arising from the AB test, and sending the email to at least one recipient.

In embodiments of the invention, a computer-implemented method of generating short text variations for AB testing for digital communication management comprises: receiving, on a first server, a user-supplied short text via a GUI; presenting to the user via the GUI a plurality of dimensions for varying a characteristic of the short text; receiving, on the first server, a user-selected dimension from the plurality of dimensions; sending the user-supplied short text and the user-selected dimension to a short text variation generator; applying, by the short text variation generator, a logic rule to the short text based on the user-selected dimension.

In embodiments of the invention, the logic rule comprises: querying whether the user-supplied short text is characterized by the user-selected dimension; and generating a dimension-customized LLM prompt based on whether the user-supplied short text is characterized by the user-selected dimension.

In embodiments of the invention, the method further comprises sending, to an LLM, the user-supplied short text and the dimension-customized LLM prompt; receiving from the LLM at least one short text variation; choosing the variation; and displaying the short text variation to the user.

In embodiments of the invention, the short text is SMS. In other embodiments, the short text is a subject line.

In embodiments of the invention, the user selected dimension is one selected from varying whether the short text (a) comprises personalization, (b) comprises a question, (c) is less than a threshold length, and (d) comprises at least one emoji.

In embodiments of the invention, the method further comprises creating the AB test based on the chosen short text variation, the user-supplied short text, and a set of default test parameters.

In embodiments of the invention, the method further comprises running the AB test, wherein the AB test comprises tracking recipient actions.

In embodiments of the invention, the method further comprises generating a SMS comprising a winning short text, and sending the SMS to at least one recipient.

In embodiments of the invention, a system for generating short texts for electronic messages for digital communication management for a user comprises a front-end server and an AB short text variation generator.

In embodiments of the invention, the front-end server is programmed and operable to: receive a user-supplied short text; present to the user a plurality of dimensions for varying a characteristic of the short text; receive a user-selected dimension from the plurality of dimensions; send the user-supplied short text and the user-selected dimension to a AB short text variation generator; choose the short text variation from candidate short text variations returned by the AB short text variation generator; and display the chosen short text variation.

In embodiments of the invention, the system further comprises: an AB short text variation generator in electronic communication with the front-end server through a network, wherein the AB short text variation generator programmed and operable to: apply a logic rule to the user-supplied short text based on the user-selected dimension.

In embodiments of the invention, the logic rule comprises: querying whether the user-supplied short text is characterized by the user-selected dimension; and generating a dimension-customized LLM prompt based on whether the user-supplied short text is characterized by the user-selected dimension.

In embodiments of the invention, the AB short text variation generator is further programmed and operable to send, to an LLM, the user-supplied short text and the dimension-customized LLM prompt; receive from the LLM the candidate short text variations; and return to the front-end server the short text variations.

In embodiments of the invention, the presented plurality of dimensions comprise at least one of: (a) varying whether the short text comprises personalization, (b) varying whether the short text comprises a question, (c) whether the short text is less than a threshold length, and (d) varying whether the short text comprises at least one emoji.

In embodiments of the invention, the system further comprises an AB test manager server operable to create and run the AB test, and wherein the AB test manager is operable to track actions of the recipient of the electronic messages.

In embodiments of the invention, the system further comprises an ESP operable to generate bulk electronic messages comprising a winning short text arising from the AB test, and send the bulk electronic messages to the recipients.

In embodiments of the invention, the short text is SMS. In other embodiments, the short text is a subject line.

Another embodiment of the invention includes a computer-implemented method for generating subject lines for electronic messages for digital communication management. The method includes receiving, by a server, information related to the digital communication management, preprocessing, by the server, the received information, receiving a plurality of N subject lines generated based on the preprocess received information from a generative text engine model, sending a merchant user ID and the plurality of N subject lines to a trained inference model; computing, on the trained inference model, a predicted score for each of the plurality of N subject lines; ranking, on the server, the plurality of N subject lines based on the predicted scores; reducing the N subject lines down to M subject lines, and displaying M subject lines to a merchant user. For an embodiment, reducing the N subject lines down to M subject lines includes filtering the N subject line to eliminate subject lines based on for instance, sensitive content, and generating similarity scores between each of the N subject lines and eliminating one or more subject lines based on a similarity with one or more other subject lines.

Another embodiment of the invention includes a system for generating subject lines for electronic messages for digital communication management. The system includes a merchant server and a management server. For an embodiment, the management server is electronically connected to the merchant server through a network. For an embodiment, the management server is configured to receive information related to the digital communication management, preprocessing the received information, retrieve a plurality of N subject lines generated based on the preprocess received information from a generative text engine model, send a merchant user ID and the plurality of N subject lines to a trained inference model; compute, on the trained inference model, a predicted score for each of the plurality of N subject lines; rank, on the server, the plurality of N subject lines based on the predicted scores; and reduce the N subject lines down to M subject lines. For an embodiment, reducing the N subject lines down to M subject lines includes filtering the N subject line to eliminate subject lines based on content, generating similarity scores between each of the N subject lines and eliminating one or more subject lines based on a similarity with one or more other subject lines, and communicate the M subject lines to the merchant server, wherein the merchant server is configured to display the M subject lines to the merchant user.

Optionally, a fine-tuned enhancer model is applied to enhance existing content for a selected one or more of the M subject lines, and displaying M subject lines with the enhanced content to the merchant user.

In embodiments of the invention, an inference model is trained to predict success based not only on features arising from a single subject line, but also the historical range of subject lines that a merchant user has used in their emails.

In embodiments of the invention, training the inference model is based on a plurality of features derived from historical data corresponding to at least one past campaign associated with the merchant user ID and, in preferred embodiments, excludes historical data associated with another merchant user ID.

In embodiments of the invention, the features are based on recorded customer behaviors such as, for example, average open rate.

In embodiments of the invention, the features comprise textural, structural, behavioral, and derived-type features.

In embodiments of the invention, the features comprise subject lines with and subject lines without emojis.

In embodiments of the invention, the features comprise subject lines with and subject lines without personalization.

In embodiments of the invention, the features comprise subject lines categorized by length or subject lines categorized by use of punctuation.

In embodiments of the invention, the features comprise all previously sent subject lines.

In embodiments of the invention, the features comprise subject line clusters derived by categorizing each previous subject line from the historical data into one of a plurality of subject line clusters, optionally twelve (12) clusters.

In embodiments of the invention, the features comprise similarity/dissimilarity statistics and the similarity/dissimilarity statistics comprise at least one of: Average Cosine Similarity between the current subject line and a previously sent subject lines; and Weighted Cosine Similarity where each similarity score is weighted by the open rate of the previously sent subject line, such that high performing subject lines have more weight when computing the average similarity.

In embodiments of the invention, the features comprise Surprise or Average Cosine Dissimilarity (how different the subject line is from previously sent subject lines); and p25/p75 similarity—statistics to detect outliers of the average similarity/dissimilarity.

In embodiments of the invention, the training of the inference model for a subject line associated with a merchant user ID excludes historical data associated with another merchant user ID.

### Objects and Advantages

Embodiments of the invention serve to simplify the desired experimentation process, allowing customers who don't have time to create multiple versions of their content to set up experiments effortlessly.

In an exemplary AB experiment, the following steps are run:
1) Hypothesis and define the type of test (e.g., email subject line, text in SMS, call to action, etc.);
2) Create variations;
3) Define the metric, test size and duration;
4) Run the test; and
5) Analyze the results and find the insights.

While steps 3-5 can be addressed by providing default values for experiments, randomizing audiences automatically, and analyzing results to deliver conclusions, the steps 1-2 of developing a hypothesis, defining the type of test to run, and creating multiple variations can be particularly challenging.

Embodiments described herein address this challenge and users don't need extensive knowledge of experimentation. In embodiments described herein, users are prompted to select the type of test from a short, curated list, making the process so straightforward that even those who have never run an experiment before can easily create one.

As described herein, one of the biggest challenges to running an experiment is creating multiple variations, as users often struggle to find the time to create even a single version of their communication.

In embodiments described herein, a second variation of content is automatically generated based on the user's selections and their first version, eliminating the need for one to manually create variations from scratch.

Embodiments of the invention reduce the time to create an experiment and allow users the opportunity to learn what increases engagement metrics and conversions, delivering relevant results—automatically through programmed computing platforms.

The following objects and advantages are provided in embodiments of the invention described herein:

Accessibility for all skills. Embodiments of the invention described herein reduce barriers to creating an experiment by presenting ready-to-use options (e.g., dimensions) for users to select, enabling those who have never created an experiment to do so with minimal knowledge required.

Time savings. Embodiments of the invention described herein decrease the time required to create an experiment by automating the creation of the second version of the content.

Improved decision making. Embodiments of the invention described herein facilitate AB testing, the result of which provides a “winner.” For example, a cohort of recipients may be reserved until a winning variation is determined, then that winner will be sent to the cohort, thereby maximizing marketing lift or performance. The decision for which electronic message to send is thus improved.

Scalability. The invention described herein serves to increase engagement metrics and conversions with minimal investment. The invention described herein enables the user to send a more effective message to more recipients thus increasing scalability.

The field of electronic message management in digital communication still suffers from delivering ineffective messages and lacks automated tools to improve the effectiveness of the digital communications. For example, there is no tool to suggest a subject line variation as described herein for AB testing. Embodiments of the present invention solve this challenge by automatically providing subject line testing variations based on a plurality of different dimensions submitted by the user and processed by the subject line generator described herein. In accordance with the invention, a meaningful subject line AB test variation can be created to improve the effectiveness of a subject line of an electronic message. This is a significant improvement over previous manual-type methods, which tend to provide less relevant and less diverse subject line variation, and produce fewer effective results.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system for automatic subject line generation for electronic messages of an electronic campaign of a merchant, according to an embodiment.

FIG. 2 shows another system for automatic subject line generation for electronic messages of an electronic campaign of a merchant, according to another embodiment.

FIG. 3 shows another system for automatic subject line generation for electronic messages of an electronic campaign of a merchant, according to another embodiment.

FIG. 4 shows another system for automatic subject line generation for electronic messages of an electronic campaign of a merchant that further include training of discriminator and/or fine-tuned enhancer models, according to another embodiment.

FIG. 5 is a flow chart that includes steps of a method for automatic subject line generation for electronic messages of an electronic campaign of a merchant, according to another embodiment.

FIG. 6 is a flow chart that includes steps of a method for improvement cycles of discriminators and the text generator of an automatic subject line generation, according to an embodiment.

FIG. 7 is a flow chart that includes steps of a method for automatic subject line generation for electronic messages of an electronic campaign of a merchant, according to an embodiment.

FIG. 8 shows a more detailed system for automatic subject line generation, according to an embodiment.

FIG. 9 is a schematic diagram of another system for automatic subject line generation for electronic messages for digital communication management, according to an embodiment.

FIG. 10 is a flow chart that includes steps of a method for automatic subject line generation for electronic messages for digital communication management, according to an embodiment.

FIG. 11 is a flow chart of a method for creating a subject line variation for AB testing as part of a digital communication management strategy, according to an embodiment of the invention.

FIGS. 12A-12E collectively depict a more detailed method for creating a subject line variation for AB testing as part of a digital communication management strategy, according to an embodiment of the invention.

### DETAILED DESCRIPTION

The embodiments described include methods, apparatuses, and systems for generating and improving subject lines for electronic messages for digital communication management. Improved subject lines result in better performance of the digital communication management.

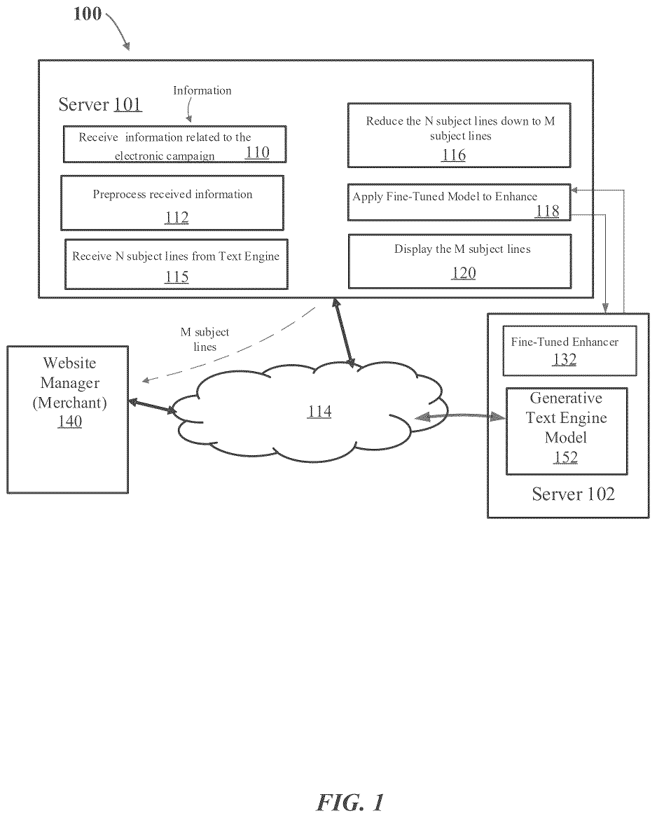

FIG. 1 shows a system 100 for automatic subject line generation for electronic messages of a digital communication management strategy (e.g., an electronic campaign) of a merchant, according to an embodiment. The system 100 includes a server 101 that is connected through an electronic network 114 to at least a merchant server 140. For an embodiment, the merchant server manages a merchant website. It is to be understood that the term “merchant” is being used liberally. That is, a merchant includes any type of business owner. For example, a merchant can include, without limitation, retail store owner, an online store owner, a teacher, a doctor, a restaurant owner, etc. Further, it is to be understood that at least some embodiments for generating subject lines for electronic messages of electronic campaigns are implemented at the server 101 which is accessed by the merchant on a client side of the server 101. Specifically, for an embodiment, the generation of the subject lines for electronic messages of electronic campaigns are performed by a UI (user interface) of the server 101.

For an embodiment, the server 101 receives 110 information related to the electronic campaign. For an embodiment, the electronic campaign provides a means for the merchant to market product and/or services of the merchant. The information includes, for example, a campaign type, a name, product, promotion, and/or brand name and/or description. Further, for at least some embodiments, the information further includes data on prior campaign information and activity undertaken by the merchant on the server 101. The server 101 may have this prior campaign information or may have access to the prior campaign information.

For an embodiment, the server 101 further operates to preprocess 112 the received information. For at least some embodiment, the preprocessing 112 includes, for example, employing formatting checks, removing keywords that could impact the performance of the text generator, and ensuring that the merchant provides sufficient information.

For an embodiment, the server 101 provides the preprocessed received information to a generative text engine model 152, and then the server 101 receives (115) a plurality of N subject lines generated based on the preprocessed received information from the generative text engine model 152. For an embodiment, the generative text engine model 152 returns text based on a given text prompt, attempting to match a pattern provided to it. For an embodiment, the generative text engine model is built on the AI (artificial intelligence) technology that is trained on large amounts of sample text such that with appropriate guidance, the generative text engine model 152 is capable of generating new text in human-readable sentences. For at least some embodiments, the generative text engine model 152 is trained further using tracked merchant and/or customer action data to improve the generative text engine model 152.

For an embodiment, the server 101 operates to reduce (116) the N subject lines down to M subject lines.

### Reducing the Number of Subject Lines

The number of N subject lines can be reduced (116) to M subject lines based on various factors, which can be based on, for example, performing formatting, length, and content checks of the subject lines.

For an embodiment, reducing the number of subject lines includes filtering the N subject lines to eliminate subject lines based on content. For an embodiment, content of subject lines that includes inappropriate and/or sensitive words are filtered out. That is, for an embodiment, subject lines that include the questionable content are eliminated.

For an embodiment, subject lines having greater than a character threshold number of characters are reduced or eliminated. For example, for an embodiment, the server 101 performs checks on the number of characters in the subject lines and only allows, for example, one subject line above 50 characters. If all the subject lines fail the character threshold number, then a new set of subject lines are generated.

For an embodiment, the post processing (processing of the subject lines after generation by the text engine model 152) further includes fixing subject lines with capitalization issues. For example, a generating subject line might include “you'll love our sale” which may be fixed to “You'll love our sale”. This additionally can be applied to subject lines enclosed in extraneous punctuation marks.

For an embodiment, reducing the number of subject lines includes generating similarity scores between each of the N subject lines and eliminating one or more subject lines based on a similarity with one or more other subject lines. That is, it can be desirable for each of the subject lines to be diverse relative to the other subject lines. Accordingly, a similarity score can be used to eliminate subject lines that are relatively similar compared to other of the subject lines. Note that it is possible to eliminate all be one unique subject line.

For an embodiment, cosine similarity scores are computed between subject lines using established vectorization methods. Namely, for an embodiment, the subject lines are embedded as vectors, and the projection of the two vectors on one another quantifies the syntactic similarities between the two subject lines. For an embodiment, when subject line pairs are determined to have high similarity scores, only one subject line of the pair is kept of the two subject lines. For an embodiment, the threshold is determined experimentally to determine what threshold of similarity works well. For an embodiment, a same similarity algorithm is run to compute pairwise similarity between each of the subject lines and the merchant-provided description, ensuring sufficient subject line difference from merchant inputs.

For an embodiment, the cosine similarity process includes taking two text strings and embedding them as vectors, meaning that the words of the text string are translated into a mathematical object that includes numbers that can be crunched (processed). For example, “My name is Josh” may be embedded as [1, 1, 1, 1, 0, 0] and “My name is John Smith” may be embedded as [1, 1, 1, 0, 1, 1]. The “cosine similarity” between these two vectors is the “distance” spanned by these two vectors, the shorter this distance, the more similar are the strings. For an embodiment, the cosine similarity threshold is selected to be ~0.8, meaning if the cosine similarity calculated is >0.8ish, the strings are too similar and one of the strings is eliminated and not show both to the user (merchant or customer).

As previously stated, it can be desirable to include diversity across the subject lines. For an embodiment, subject lines are maintained based on pairwise similarity scores. For an embodiment, if two subject lines are within a threshold of similarity, and therefore, highly similar, one of the subject lines is excluded to avoid a case of users (merchants) being presented with a narrow range of options to choose from.

For at least some embodiments, the cosine similarity scoring is applied to not just between subject lines, but also between subject lines and the merchant providing description (text). That is, for example, it is undesirable for a merchant to ask for subject lines for a “Memorial Day Sale”, and for the subject line generator to then provide the subject line “Memorial Day Sale” or “Memorial Day Sale!” or something similar. For at least some embodiments, the similarity threshold used for determining that similarity between subject lines is different than the similarity threshold used for determining the similarity threshold between subject lines and the merchant provided description. Both of the similarity thresholds can be experimentally determined. Further, they can be adaptive from one merchant to the other.

For an embodiment, if the described methods of reducing the number of subject lines results in less than a threshold number of subject lines, the server 101 operates to resend a request for information (additional subject lines) from the generative text engine model 152.

### Fine-Tuned Enhancer Model(s) for Enhancement

For at least some embodiments, a fine-tuned enhancer model 132 can be applied (118) to enhance existing content for a selected one or more of the M subject lines. That is, the remaining M subject lines are enhanced by the fine-tuned enhancer model 132 by adding content. For an embodiment, applying (118) the fine-tuned enhancer model 132 to enhance existing content includes adding emojis to the selected one or more of the M subject lines. For an embodiment, the inclusion of emojis, for instance, is determined by training an enhancement model on historical subject line-emoji pairs, gathering an emoji selection by calling the enhancement model on a subject line, and appending the emojis to the subject line according to predetermined patterns.

For at least some embodiments, applying the fine-tuned enhancer model 132 to enhance existing content includes adding information to enhance the selected one or more of the M subject lines. For an embodiment, the process for selecting and adding the enhancements includes identifying the nature of the content presented in the subject line and appending relevant emojis based on the content, allowing merchant users the ability to automatically adjust the tone of the subject lines based on their brand tone and adding best practice keywords to improve the success rate of the subject lines. For an embodiment, adding enhancements includes altering one or more keywords of the subject line(s). For example, adding enhancement could include highlighting that merchant users should be using the word “Offer” instead of “Discount” based on previously collected data on what works best for end-recipients (for example, customers).

For at least some embodiments, the fine-tuned enhancer model 132 is applied to a randomly selected one or more of the M subject lines. For an embodiment, one of the M subject lines that make it through the post processing check is selected with equal probability for adding additional subject matter, such as, an emoji. A random selection for post process checking can be advantageous because there is no bias in subject line selection. However, at least some embodiments include at least some intelligence in the subject line selection for enhancement. For an embodiment, it may be clear that an enhancement would improve one subject line but not others, and therefore, in this case only that subject line would be selected, and not the other subject lines.

At least some embodiments include multiple fine-tuned enhancer models. For example, one fine-tuned enhancer model may be applied to subject lines, and another for subject line enhancement, such as, emojis.

For at least some embodiments, after application of the fine-tuned enhancer model, the M subject lines with enhanced existing content are displayed (120) to a merchant user at the merchant server 140.

For an embodiment, the fine-tuned enhancer model 132 and the generative text engine model 152 operate on an exemplary server 102. However, clearly the fine-tuned enhancer model 132 and the generative text engine model 152 can operate on any configurations of multiple servers.

### Tracking Merchant Actions

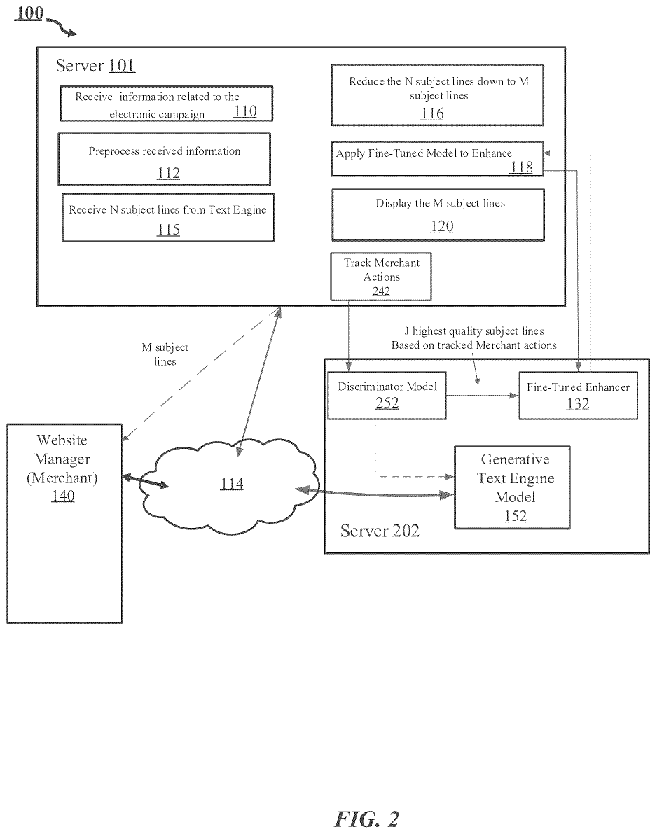

FIG. 2 shows another system for automatic subject line generation for electronic messages of an electronic campaign of a merchant, according to another embodiment. For this embodiment, the server 101 additionally tracks merchant actions 242 based on the M subject lines displayed to the merchant of the merchant server 140. For at least some embodiments, the tracking of the merchant 242 includes the tracking the merchant clicking to select a displayed subject line of the M displayed subject lines. Clicking the displayed subject line indicates an interest by the merchant in the selected subject line and indicates a level of value of the selected subject line. For an embodiment, tracking of the merchant includes tracking the merchant modifying the subject line, and submitting a final revised subject line. Modifying a selected subject line provides a level of value of the modified and submitted subject line.

For an embodiment, a discriminator model 252 operates to assign a quality rating for each of the M subject lines based on the tracked merchant actions. For an embodiment, the discriminator model 252 is provided examples of subject lines and whether or not a merchant clicked on, “liked”, or performed some other action showing interest in a generated subject line. This allows the discriminator model 252 to predict whether or not a merchant will “like” a subject line that the generator comes up with, and based on the discriminator's predicted probability that the merchant will “like” the subject line, the X subject lines with the highest X “quality ratings” can be chosen and then those X subject lines can be shown to the user (merchant), since they're the “best” of the group of subject lines.

For an embodiment, different tracked merchant actions suggest a different level of quality of each of the subject lines. Accordingly, different specific actions, and/or combinations of actions performed by the merchant on the displayed M subject lines can yield a different ranking of the subject lines.

For an embodiment, the discriminator model 252 is trained on historical tracked merchant actions on previously generated subject lines, wherein the historical merchant actions include selection, editing, and actual use of a subject line in a campaign. For an embodiment, the trained historical model is equipped to assign a quality rating to new, previously unseen M subject lines after the subject lines have been generated, allowing selection of the predicted top-performing subject lines to display to the merchant.

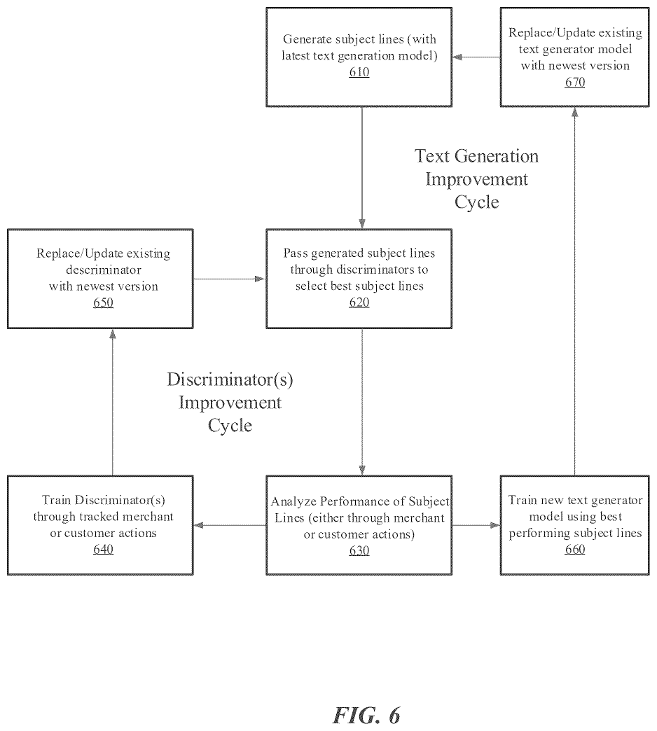

An embodiment further includes continuously updating the generative text engine model subject line generator models based on continuously tracked merchant and customer actions. The continuous updating of the generative text model is shown in FIG. 6.

For an embodiment, the fine-tuned enhancer model 132, the discriminator model 252, and the generative text engine model 152 operate on an exemplary server 202. However, clearly the fine-tuned enhancer model 132, the discriminator model 252, and the generative text engine model 152 can operate on any configurations of multiple servers.

### Tracking Customer Actions

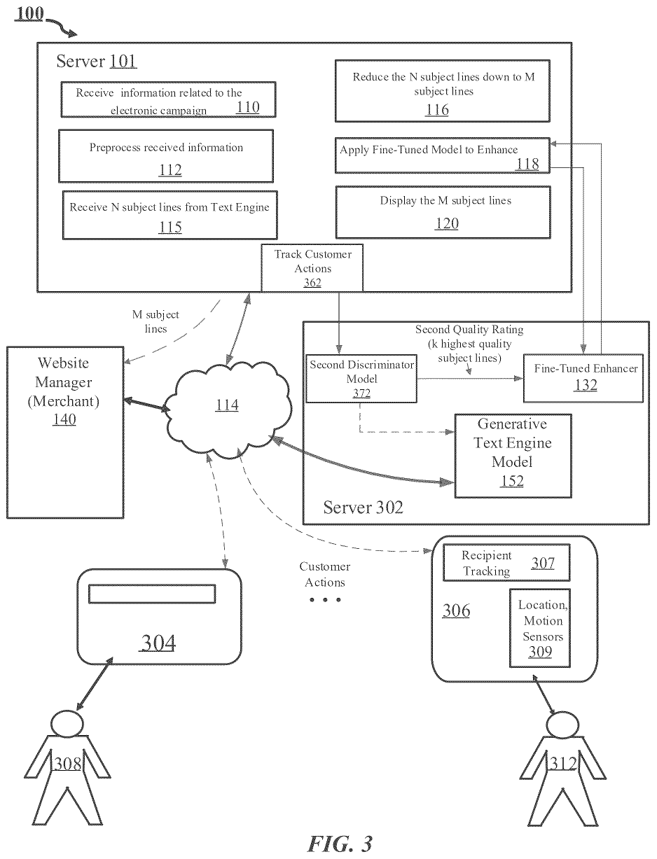

FIG. 3 shows another system for automatic subject line generation for electronic messages of an electronic campaign of a merchant, according to another embodiment. FIG. 3 further includes customer devices 304, 306 of customers 308, 312 that are electronically connected to the server 101 and the merchant server 140 through, for example, the network 114. This embodiment further includes the server 101 tracking customer actions 362 based on the subject lines displayed to one or more customers 308, 312 of the merchant of the merchant server 140.

For an embodiment, the tracking of the customers includes tracking online activity and action by the customers. For an embodiment, a customer device (such as, devices 304, 306) alone or in conjunction with the server 101, or the merchant server 140 operates to sense the customer action data. For an embodiment, the sensed and tracked customer action data includes the customer device electronically sensing a customer performing an action or activity.

While the described embodiments are directed towards sensing customer action data, it is to be understood that at least some other embodiments can additionally or alternatively include the sensing of other types of data as well. For an embodiment, the sensed data can include merchant server data, such as, daily total or new visitors on the merchant website. That is, the sensed customer action data could be replaced with, for example, data of daily total or new visitors on the merchant website.

The customer action data may be tracked (counted) over various possible time periods (such as, by the second, minute, hour, day, week, or month) and may include one or more of customers (308, 312) being active on the website of the merchant server 140, a sent email bouncing, a customer canceled order, a customer starting a checkout, a customer clicking (selecting) an email, a customer opening email, a customer placing order, a customer receiving email, a customer refunding an order, a customer unsubscribing, a customer viewing a product, a customer adding to a list (a list in the marketing automation platform of the server 101 account), and/or a customer adding an item to their cart.

It is to be understood, however, that there are very few limitations on what event types (customer actions) can be published (provided) to a marketing automation platform of the server 101. Website managers (such as website manager of merchant server 140) can implement their own events (sensed customer actions) that make sense for their business and simply send those events over to the marketing automation platform of the server 101.

Further, as will be described, implementations of the devices 304, 306 that include mobile devices can additionally or alternatively include additional types of sensed customer actions. Such sensed customer action can include sensing a physical customer visit and/or purchase. That is, the sensing of the customer action can include sensing the customer visiting a physical location of the merchant, and/or the customer purchasing a product or service of the merchant at a physical store location of the merchant. Further, the sensed customer actions can include combinations or sequences of customer actions. For an embodiment, sensed customer actions are weighted based on the sensed customer actions. For an embodiment, only sensed customer actions having a weight, or a combination of weights that exceed a customer action threshold are considered a customer action for the purposes of detecting customer actions.

For an embodiment, the location monitoring of the mobile device of the customer is used to identify business locations visited by the recipient after receiving the campaign. Different businesses can be rated, wherein particular businesses yield a higher customer action score, and other particular businesses yield a lower engagement score. The customer action score of each business can be adaptively adjusted based on the electronic campaign of the merchant and can be adjusted based on other businesses visited by the recipient. For an embodiment, patterns of location visits by the recipient can be used to influence the level of customer action.

For an embodiment, motion of the recipient is tracked by location and motion sensors 309, and can be used to influence the level of customer action. Certain actions (motions) of the recipient may indicate different levels of customer action. For an embodiment, the computing devices 304, 306 may include a mobile phone, a smart watch, or a headset. Motion of the recipient can include tracking hand motions, direction of eyesight, and/or orientations of the recipient. Accordingly, whether the recipient is in a physical location of a product of the merchant can be determined. Further, how long the recipient holds or looks at a specific product of the merchant can be determined. Further, whether the recipient interacts with another recipient can be determined. All the sensed/tracked locations and motions of the customer can be included within a score of the customer action. Again, a score that exceeds a score threshold can be deemed a customer action. The actions and locations of the customer can be tracked 307 allowing patterns in the customer behavior to be determined. As described, sequences of behaviors by the customer can be ranked for determining of a score which is used for determining whether a customer action has occurred.

Further, for an embodiment, different businesses physically visited can be rated, wherein particular businesses yield a higher success score and other particular businesses yield a lower success score. The success score of each business can be adaptively adjusted based on campaigns and can be adjusted based on other businesses visited by the customer. For an embodiment, patterns of location visits by the customer can be used to influence the level of success. That is, for example, visiting a location of a business can be rated higher or lower based on a previous business visited by the customer.

As previously described, the customer tracking can include monitoring of web browsing of the customer. Online action and activity of the customer can influence the success score. Links accessed by the customer can be tracked. Websites visited by the customer can be tracked. Online purchases of the customer can be tracked. Each of the online web browsing of the customer can influence the success score of the customer actions.

For an embodiment, customer tracking is performed by including a tracking pixel on an email that is sent to a customer, and detecting by the tracking pixel when the email is opened.

For an embodiment, customer tracking is performed by tracking links. For embodiments, links within the email can be tagged with unique identifiers. When a recipient clicks on a link, the server records the click event and tracks which links are being clicked and by whom.

For an embodiment, customer tracking is performed by tracking the IP address. When an email is opened or a link is clicked, the server can collect the recipient's IP address, which can be used to infer their approximate location and the device they are using.

For an embodiment, customer tracking is performed by tracking cookies. Cookies (namely, web or internet cookies) are small blocks of data created by a web server while a user is browsing a website and placed on the user's computer or other device by the user's web browser. Cookies are placed on the device used to access a website, and more than one cookie may be placed on a user's device during a session. When the user visits the website again, the browser sends the stored cookie back to the website. This allows the website to track user activity.

For an embodiment, relationships between different customers are determined. For example, web tracking can determine online relationships between customers. Further, for an embodiment, a real physical relationship between customers can be established by tracking the locations of the different customers. Two customers may be identified as living together based on location tracking. Further, commonalities of recipients can be determined by identifying common locations, or common types of locations between the different customers. The influence one customer has on another customer can be measured and the influence can add or subtract from the success score.

For an embodiment, a level of customer action can be adaptively adjusted for each customer based on actions of an associated customer. An action by a related or common type of customer can influence how much an action by a customer influences the engagement determination or influences a success determination.

As previously described, the success determination of the described customer actions can be scored, and a score exceeding a score threshold can qualify as a customer action which is tracked.

For an embodiment, a second discriminator model 372 assigns a second quality rating for each of the subject lines displayed to the one or more customers based on the tracked customer actions. For an embodiment, the rankings of the customer actions influence the second quality rating of each of the subject lines. For an embodiment, the second discriminator model 372 is trained on historical tracked customer actions on previously generated subject lines, including opens of and clicks in email campaigns with a certain subject line. With this training the model assigns a quality rating to new, previously unseen M subject lines after they have been generated, allowing selection of the predicted top-performing subject lines to display to the merchant.

At least some embodiments include supplementing data used to train the fine-tuned enhancer model 132 with K highest quality rating subject lines as determined by actions of the one or more customers.

At least some embodiments further include continuously updating the generative text engine model 152 based on continuously generated second quality ratings as determined by the second discriminator model 372. A process for enhancing the operation of the generative text engine model 152 is shown in FIG. 6.

For at least some embodiment, assigning by the second quality rating by the second discriminator model comprises receiving, by the merchant server, customer actions for electronic messages having different subject lines and the same message content. An embodiment includes a form of AB testing. For an embodiment, when it comes to forms or messages of an electronic campaign, the testing includes the creation of an “all things being equal” experiment, with one single difference that is hypothesized to generate better performance. For an embodiment, in the case of subject lines, a user (merchant) may choose to AB test two subject lines, one from the generator, and one that the user (merchant) creates themselves, wherein the messages or forms are identical, but the subject lines are different. Further, for an embodiment, two generated subject lines can be AB tested against each other, wherein the subject lines of two electronic messages are different, but the content of the electronic messages are identical. This allows for testing of the quality of the subject lines against each other which can be used to further advance the quality ratings of the different generated subject lines. For the purpose of assigning quality ratings through the discriminator that can predict best merchant reception, and through the second discriminator that can predict best customer reception, a combination of the two, rather than a competition between the two, the quality ratings assigned by each of these two discriminators can be utilized.

For an embodiment, the fine-tuned enhancer model 132, both discriminator models 252 and 372, and the generative text engine model 152 operate on an exemplary server 302. However, clearly the fine-tuned enhancer model 132, both of the discriminator models 252 and 372 and the generative text engine model 152 can operate on any configurations of multiple servers.

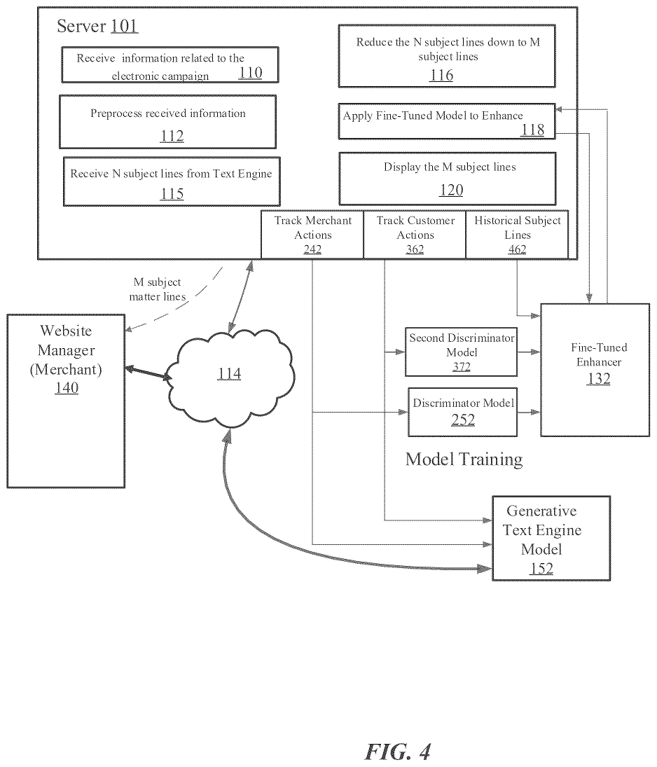

FIG. 4 shows another system for automatic subject line generation for electronic messages of an electronic campaign of a merchant that further include training of discriminator and/or fine-tuned enhancer models, according to another embodiment. For an embodiment, the first discriminator model 252 and the second discriminator model 372 both simultaneously provide highest quality subject lines to the fine-tuned enhancer model 132. For an embodiment, discriminator models can be used together to create a conclusive quality rating by for example creating a weighted sum of the outputs of the two models. For an embodiment, one of the discriminator models has a greater influence on the quality rating than the other of the discriminator models. For example, when a quality rating of one of the discriminator models suggests a very high quality (greater than a predetermined threshold) then that discriminator model provides the dominant quality rating. For example, the actions of the merchant user may indicate one subject line to have a high quality. However, the customer action may indicate that one other subject line is substantially (greater than the predetermined threshold). For an embodiment, the customer actions provide a better subject line quality indication than the merchant actions. Accordingly, in this case, the second discriminator model has a greater influence on the quality of the subject lines than the discriminator model.

For an embodiment, the discriminator 252 and the second discriminator 372 are combined to form a single discriminator model that is trained using data consists of both merchant and customer actions.

FIG. 4 further includes historical subject lines 462. This includes the tracking of past subject lines and the successes of the past subject lines. These successes can be used to improve the generation of future subject lines.

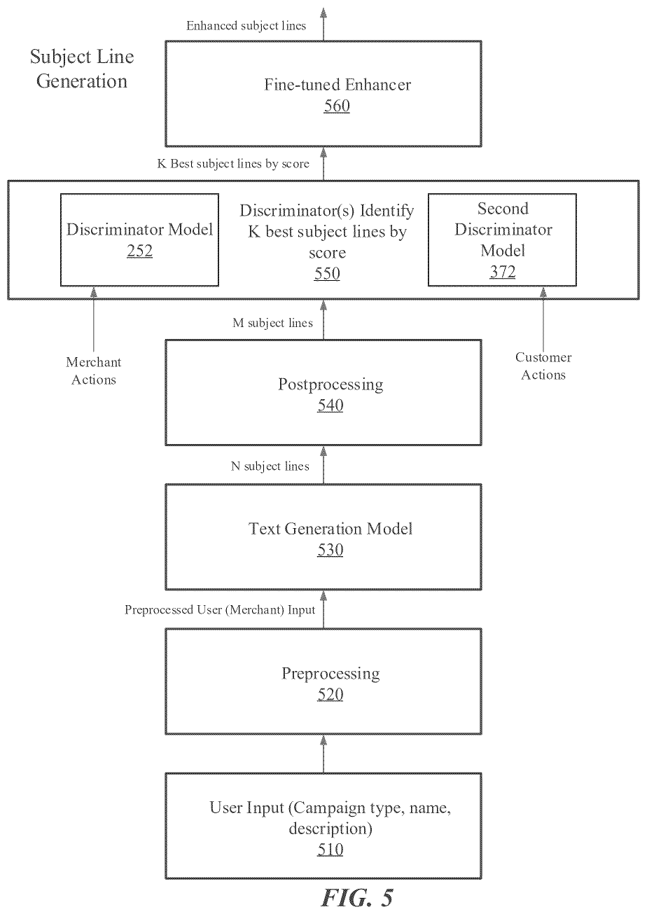

FIG. 5 is a flow chart that includes steps of a method for automatic subject line generation for electronic messages of an electronic campaign of a merchant, according to another embodiment. As shown, a first step 510 includes receiving the merchant user inputs related to an electronic campaign. As previously described, the merchant user inputs include, for example, a campaign type, name, description, etc. A second step 520 includes preprocessing the merchant user inputs. As previously described, the preprocessing can include, for example, employing formatting checks, removing keywords that could impact the performance of the text generator, and ensuring that the merchant provides sufficient information. A third step 530 includes providing the preprocessed merchant input information to a text generation model which generates N subject lines that could be used by the merchant for an electronic campaign. A fourth step 540 includes postprocessing the N subject lines to reduce the number of subject lines down to M subject lines. The number of subject lines can be reduced by one or more of the many described embodiments for reducing the number of subject lines. A fifth step 550 includes identifying the K best subject lines of the M subject lines. For at least some embodiments, the K best subject lines are identified based on actions of merchant users and/or customers of the merchant. The merchant user action can be provided to a discriminator model, and the customer actions can be provided to a second discriminator model. The discriminators identify the best subject lines by sensing one or more of the merchant user actions and/or the customer actions. The sensing can take any of one or more of the many described merchant users and/or customer actions. For at least some embodiments, the actions include combinations and/or sequences of action for determining the quality of each subject line. A sixth step 560 includes enhancing the K higher quality rating subject lines with additional or modified contents. The modified K highest quality subject lines can be provided back to the generative text engine model to improve future subject line generation.

FIG. 6 is a flow chart that includes steps of a flow chart of a method for improvement cycles of discriminators and the text generator of an automatic subject line generation, according to an embodiment. A first step 610 includes generating the M subject lines with the latest text generation model. As previously described, the highest quality subject lines of a prior electronic campaign are feedback to the text generation model to allow for improvement of future subject line generation. A second step 620 includes passing the generated subject lines through one or more of the discriminator model or the second discriminator model for selecting the best quality subject lines of the generated subject lines. A third step 630 includes analyzing the performance of the best quality subject lines based on actions of the merchant user and/or customer users of the electronic campaign. A fourth step 640 includes training the discriminator model and the second discriminator model based on the merchant user and the customer user actions. A fifth step 650 includes replacing/updating the discriminator model and/or the second discriminator model based on the tracked merchant user and/or customer user actions. The updating/replacing of the discriminator models is performed by a discriminator(s) improvement cycle which can be performed for every electronic campaign.

An embodiment further includes a text generator model improvement cycle. A sixth step 660 training the text generator model using the best performing subject lines as determined by the actions of the merchant users and/or the customer users. A seventh step 670 includes replacing/updating/modifying the existing text generation model with a new version.

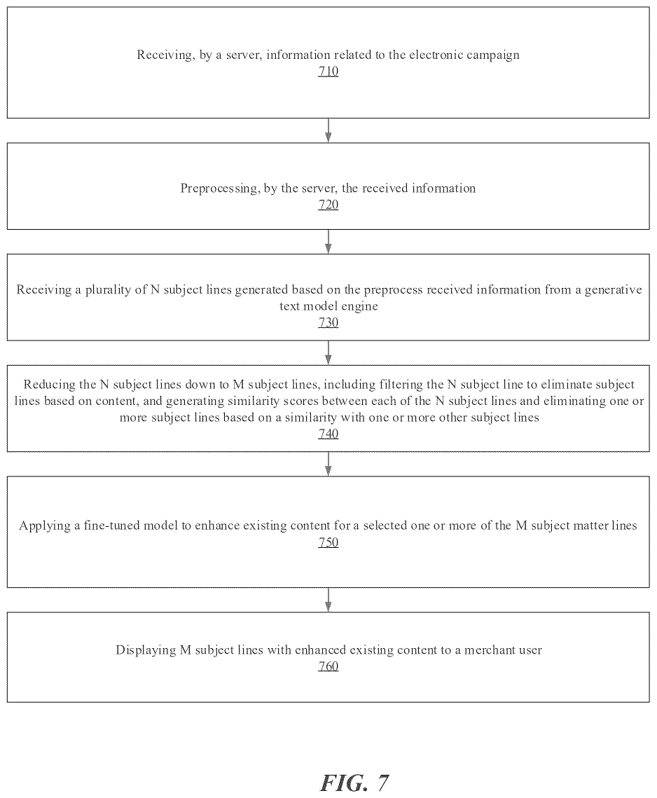

FIG. 7 is a flow chart that includes steps of a method for automatic subject line generation for electronic messages of electronic campaigns, according to an embodiment. A first step 710 includes receiving, by a server, information related to the electronic campaign. A second step 720 includes preprocessing, by the server, the received information. A third step 730 includes receiving a plurality of N subject lines generated based on the preprocess received information from a generative text engine model. A fourth step 740 includes reducing the N subject lines down to M subject lines, including filtering the N subject line to eliminate subject lines based on content, and generating similarity scores between each of the N subject lines and eliminating one or more subject lines based on a similarity with one or more other subject lines. A fifth step 750 includes applying a fine-tuned enhancer model to enhance existing content for a selected one or more of the M subject lines. A sixth step 760 includes displaying M subject lines with enhanced existing content to a merchant user.

As previously described, for an embodiment, reducing the N subject lines down to M subject lines, further comprises eliminating subject lines that have greater than a character threshold number of characters.

As previously described, for an embodiment, filtering the N subject line to eliminate subject lines based on content includes eliminating subject lines that include inappropriate and politically sensitive words.

As previously described, for an embodiment, generating similarity scores between each of the N subject lines and eliminating one or more subject lines based on a similarity with one or more other subject lines comprises computing cosine similarities between the subject lines. As previously described, for an embodiment, generating similarity scores between each of the N subject lines and eliminating one or more subject lines based on a similarity with one or more other subject lines comprises prioritizing diversity across displayed subject lines based on pairwise similarity scores.

As previously described, for an embodiment, applying the fine-tuned enhancer model to enhance existing content includes adding emojis to the selected one or more of the M subject lines. For an embodiment, enhancing the existing content is based on collected information from subject lines of past high-performing electronic campaigns and adjusting content of the subject lines to reflect a brand tone of the merchant user based on content and success of past high-performing electronic campaigns and existing website content. For an embodiment, applying a fine-tuned enhancer model to enhance existing content includes adjusting or supplementing to the selected one or more of the M subject lines. For an embodiment, the fine-tuned enhancer model is applied to a selected one or more of the M subject lines.

For an embodiment, the server is electronically connected to a merchant server. Further, the server tracks merchant actions at the merchant server based on the M subject lines displayed. A discriminator model assigns a quality rating for each of the M subject lines based on the tracked merchant actions, and supplements data used to train the fine-tuned enhancer model with J highest quality rating subject lines.

As previously described, at least some embodiments include continuously updating the generative text engine model based on continuously generated quality ratings.

As previously described, for an embodiment, the server is electronically connected to a merchant server, and to a plurality of customer devices. Further, the server, tracks customer actions of customers at the customer devices based on the subject lines displayed to one or more customers of a merchant of the merchant server. A second discriminator model assigns a second quality rating for each of the subject lines displayed to the one or more customers based on the tracked customer action, and supplements data used to train the fine-tuned enhancer model with K highest quality rating subject lines as determined by actions of the one or more customers. For an embodiment, tracking the customer actions comprises sensing the customer actions at the customer devices. For an embodiment, sensing the customer action comprises sensing online action of the one or more customers. For an embodiment, sensing the customer action comprises sensing physical motion of the customer devices of the one or more customers. At least some embodiments further include continuously updating the generative text engine model based on continuously generated second quality ratings. For an embodiment, assigning by the second quality rating by the second discriminator model comprises receiving, by the server, customer actions for electronic messages having different subject lines and a same message content.

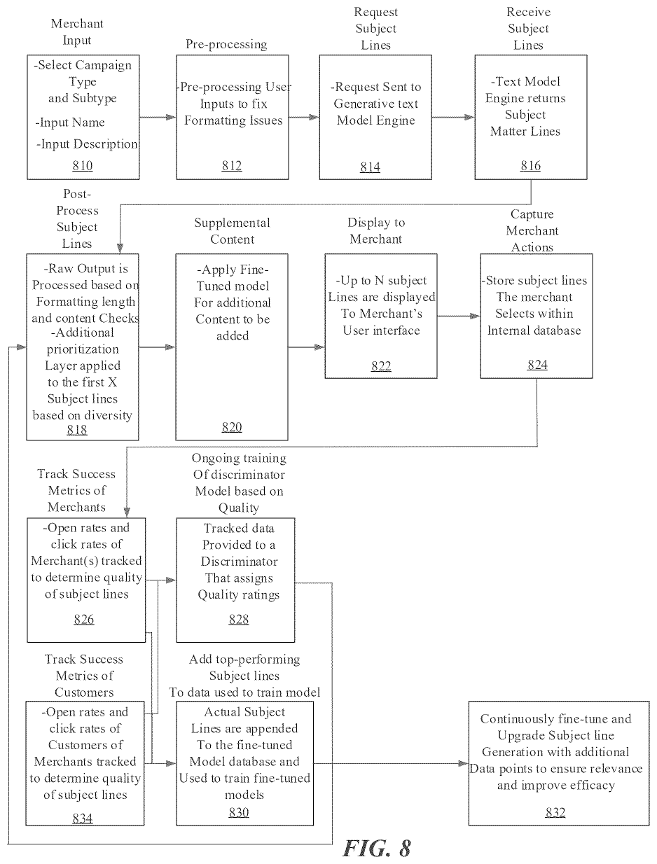

FIG. 8 is a flow chart that includes steps of another method for automatic subject line generation for electronic messages of an electronic campaign of a merchant, according to another embodiment. A step 810 includes receiving inputs from the merchant, such as, a campaign type and subtype selection. This step may be similar to step 710 of FIG. 7. A step 812 includes pre-processing user (merchant) inputs to fix any formatting issues. This step may be similar to step 720 of FIG. 7. Steps 814 and 816 include requesting and receiving subject lines from a generative text engine model. These steps may be similar as step 730 of FIG. 7. A step 818 includes post-processing of the subject lines, including formatting and content checks. This step may be similar to step 740 of FIG. 7. A step 820 includes applying a fine-tuned enhancer model to add and enhance content of the subject lines. This step may be similar to step 750 of FIG. 7. A step 822 includes displaying up to N subject lines to a user interface of the merchant. This step may be similar to step 750 of FIG. 7. A step 824 includes storing the subject lines in an internal database which can then be selected by the merchant user.

Once displayed to the merchant, the success and quality of the presented subject lines is tracked and determined. Based on the tracked success and quality of the subject lines used for electronic messaging with the merchant, a discriminator model is continuously trained. Further, for an embodiment, based on the tracked success and quality of the subject lines used for electronic messaging with customers of the merchant, a second discriminator model is continuously trained.

A step 826 includes tracking success or quality of the subject lines based on merchant actions, such as, selections, edits, and use in campaigns of generated subject lines. A step 828 includes ongoing training of the discriminator model (such as, discriminator model 252) based on the tracked successes of the subject lines.

A step 830 includes adding top-performing subject lines to data used to train the text generator model as previously shown in FIG. 6.

A step 832 includes continuously fine-tuning and upgrading the subject line generation with additional data to ensure relevance and efficacy of the future generated subject lines. By expanding the number of subject lines processed by the fine-tuned enhancer aided text generator model, the text generation model should be expected to produce text that will more closely follow patterns similar to real-life subject lines.

A step 834 includes tracking success or quality of the subject lines based on actions of customers of the merchant, such as, open and click rates of messages that include the subject lines. As previously described, the merchant actions and the customer actions are used to evaluate the quality of the subject lines presented to the merchant and/or the customer. The describe discriminators and the generative text engine model are trained based on the quality subject line quality determinations. The trained models provide better recommendations in the future, thereby improving the subject line generation over time.

Further, for at least some embodiments, the steps 828 and 830 further account for subject line success based on tracked success based on actions of the customers of the merchants.

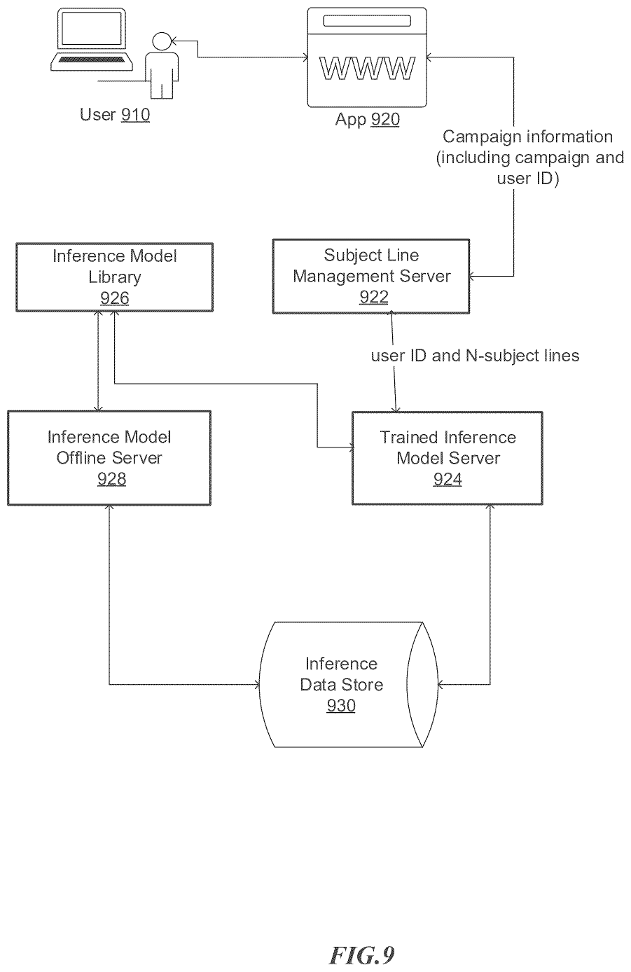

FIG. 9 shows another system for automatic subject line generation for electronic messages for a digital communication strategy (e.g., an electronic campaign) of a merchant user, according to an embodiment of the invention.

In the embodiment shown in FIG. 9, a user 910 (e.g., merchant user) enters information through an application interface 920 that is associated with the backend subject line management server 922. Exemplary information includes information relating to the merchant user's digital communication management or strategy, electronic campaign information, or digital marketing information. Such information can include, without limitation, the merchant user ID, campaign ID, and contextual information such as type/class of email and description of the subject matter of the email. Examples of types or classes of email include, without limitation, holiday sale, discount, and product launch.

The subject line management server 922 receives the information and is programmed and operable to send a prompt to a generative text engine model, discussed above, to obtain a plurality of candidate subject lines (e.g., a plurality of N subject lines) based on the information. In embodiments, 6-12 subject lines are generated.

Additionally, the subject line management server 922 automatically sends a prompt to an inference model server 924. In embodiments, the prompt includes the N subject lines and the merchant user ID or name. As discussed herein, the inference model server 924 includes a trained inference model that is operable to make a call to the inference data store 930. The request to the inference data store 930 includes the merchant user ID.

The inference data store 930 returns all the computed values corresponding to the features used to train the model, for the particular merchant's history of subject lines.

The online inference model 924 concatenates all the features related to the subject line and computes predicted scores for each of the N generated subject lines.

The subject line management server then ranks all the subject lines based on their predicted scores.

In embodiments, the subject line management server 922 further applies a filtering function to reduce the number to M subject lines, as described above. In embodiments, similar subject lines are excluded. In embodiments, M is less than or equal to 5.

The App 920 shows or displays the optimized ranking of M subject lines to the user 910.

FIG. 9 also shows inference model library 926 and inference model offline server 928.

The inference model library 926 is a library for storing and providing pre-written code to the trained online inference model 924 server and offline inference model server 928. Examples of modules in the library include, without limitation, Emoji counters, Sentence Transformer embeddings, and python string utilities.

The inference model offline server 928 is programmed and operable to pull campaign data from other databases, and to compute the values for features. For example, historical campaign data can be pulled periodically from a number of different databases such as, without limitation, cloud-based data warehousing platform Snowflake and cloud-based object storage AWS S3 by Amazon. The inference model offline server 928 also computes the values of the features for each of the companies/merchants based on the historical campaign data. The computed values for the features for each of the companies is provided to the online inference datastore 930 for use by the trained inference model server 924.

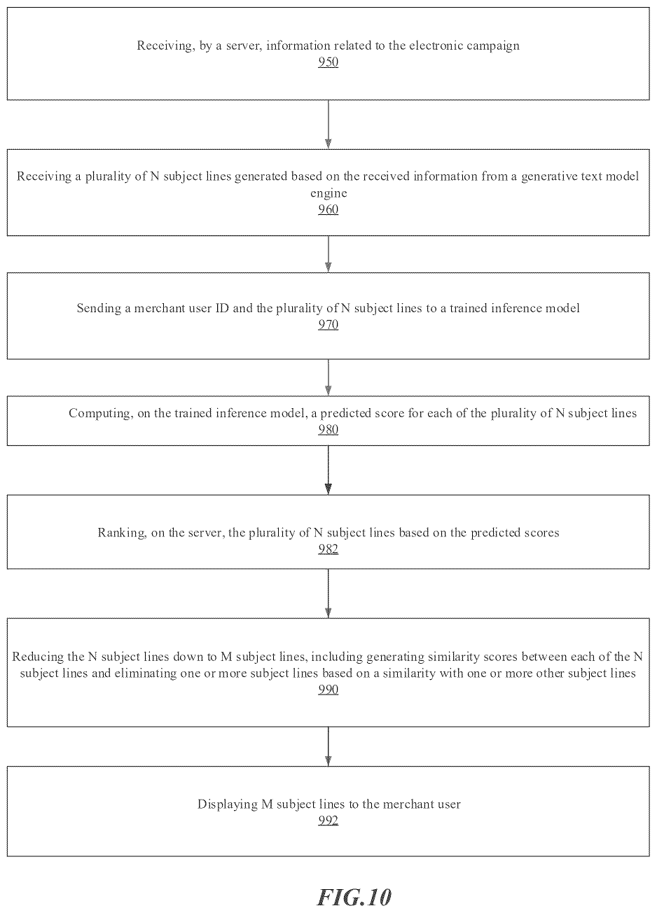

FIG. 10 is a flow chart that includes steps of a method for automatic subject line generation for electronic messages of a digital communication management strategy of a merchant, according to an embodiment.

Step 950 states receiving, by a server, information related to the digital communication management strategy. As discussed herein the server receives various types of information from the merchant user. Examples of information include structural information such as the merchant user's ID, campaign ID as well as textural information in the description of the campaign such as the type of sale desired (e.g., holiday sale).

Step 960 states receiving a plurality of N subject lines generated by a generative text model engine and based on sending the text model engine the context related information, and in some embodiments, excluding the user's ID. This step may be performed using LLM technologies to generate a plurality of N subject lines where the integer ‘N’ may vary and, in some embodiments, is between 6 and 12. An example of a suitable LLM technology is GPT-4 by OpenAI Inc. (San Francisco, CA).

Step 970 states to send the merchant user ID and the plurality of N subject lines to a trained inference model. With reference to FIG. 9, the subject line management server 922 sends this information to the trained inference model server 924. As described herein, the trained inference model is trained using certain features the inventors have found to be of consequence. The training data set includes all historical campaign data for the specific user merchant of all sent email subject lines and the customer behaviors including, e.g., email open rate. In embodiments, the data set excludes historical data of other merchant user's regardless of whether the subject lines were identical.

Step 980 states computing, on the trained inference model 924, a predicted score for each of the plurality of N subject lines. In embodiments, the trained inference model is trained on historical campaign data to receive a subject line and user merchant ID, and output a quality score representing success or likelihood the recipient shall open the electronic message. Because the inference model is trained on customized merchant user-specific datasets, the scores are user merchant dependent. Consequently, if the identical set of N subject lines is submitted to the trained inference model 924 for two different merchant users, the inference model is capable and may provide different scores for the subject lines depending on the user merchant.

Step 982 states ranking, on the management server 922, the plurality of N subject lines based on the predicted scores.

Step 990 states reducing the N subject lines down to M subject lines, including generating similarity scores between each of the N subject lines and eliminating one or more subject lines based on a similarity with one or more other subject lines. As described above, the server 101, 922 is operable to filter the ranked list of N subject lines to M subject lines.

Step 992 states displaying M subject lines to the merchant user. This step may be performed by an API 920 presenting the information to the user via their computing device 910.

### Inference Model Training

In embodiments of the invention, a method for training comprises one of more of the steps described herein.

Data Collection. In embodiments, a first step in the training process is to collect relevant historical data that can be used to predict future subject line performance. In embodiments, this step is performed by gathering data on historical campaigns from various databases for multiple merchant users. Historical data can be collected from, e.g., the merchant's email service providers, online store platforms, as well as third party marketing service provider services, such as but not limited to Shopify, WooCommerce. and MailChimp. In embodiments, the data is collected and is arranged in a csv file in rows by merchant user including columns for the merchant user ID, email subject line, and open rate. In some embodiments, at least 500 sent emails for each merchant user are collected, depending on how much historical data is present for each merchant.

Data Processing. In embodiments, the data in the data set is preprocessed. This can include: removing special characters and stop words; and removing non-English subject lines

Feature Extraction. In embodiments, the data is transformed into numerical features that can be fed into the machine learning model. The inventors have found useful a wide variety of features that are extracted to be fed into the model, discussed herein.

### A. User-Agnostic Features for Current Subject Line

In embodiments, the text of each subject line is vectorized. In embodiments, the text of the current subject line is vectorized into a 784-dimensional embedding. A non-limiting exemplary technique for creating the embedding is computing embeddings with transformer models.

### B. User-Specific Features for Historical Subject Lines

In embodiments, a method computes for each specific merchant user (e.g., Company A, B, C, etc.) various statistics including average open rates, standard deviation, and number of campaigns. These statistics are computed and aggregated over campaigns where the associated subject line included one of several attributes: (a) subject lines with and subject lines without emojis; (b) subject lines with and subject lines without personalization (e.g., user name); (c) subject lines categorized by length (short, medium, long based on number of characters in the subject line); (d) subject lines categorized by use of punctuation (low, medium, high based on number of punctuation marks); and (e) a catch-all of all previously sent subject lines

### C. Clustering

In embodiments, a method builds a clustering algorithm based on all historical subject lines for each specific merchant user. In embodiments, each subject line is grouped into one of 12 clusters or categories. In embodiments, the clusters are predetermined based on human-interpretation of these clusters. Examples of categories or clusters include, without limitation: (a) a particular type of holiday advertisement (“'Tis the Season for . . . ”), (b) a message of urgency (“Sale Ends Soon”), and (c) a discount (“15% off”), etc.

Statistics are computed over the clusters. Exemplary statistics for each cluster include: average open rates, standard deviation, and number of campaigns computed and aggregated over all campaigns where the subject line belonged to a specific cluster.

### D. Overlap

In embodiments, a method computes the overlap between the current subject line (the subject line we are interested in including or filtering out in the future) and historical subject lines. In embodiments, subject lines were embedded into a vector (e.g., 784-dimensional space) using a Natural Language Processing technologies such as BERT LLM embeddings.

After these embeddings are computed for both the current subject line and all historical subject lines, various derived features are computed relating to: (a) how similar is this subject line to previously sent subject lines and (b) how surprising/dissimilar is this subject line to previously sent subject lines. Without intending to be bound to theory, similar subject lines perform similar to one another and also, sometimes, other subject lines provide a surprise or “shock factor” that increases engagement once in a while. In embodiments, the similarity-measured derived features include: Average Cosine Similarity between the current subject line and previously sent subject lines; Weighted Cosine Similarity where each similarity score is weighted by the open rate of the previously sent subject line, such that high performing subject lines have more weight when computing the average similarity; “surprise” or Average Cosine Dissimilarity—i.e., how different the subject line is from previously sent subject lines; and p25/p75 similarity—statistics to detect outliers of the average similarity/dissimilarity

In embodiments, feature computation creates a multi-dimensional representation of a subject line with statistics related to the characteristics of the current subject line as well as characteristics of previously sent subject lines for a company and characteristics of overlap between the current subject line and previously sent subject lines. In embodiments, the feature computation creates a dimensional representation greater than 768, sometimes greater than 784, and in some embodiments, at least 863 dimensions for each subject line corresponding to textural, linguistic (sentiment score such as emotional tone), structural (e.g., metadata including the user ID, campaign ID, etc.), behavior (e.g., open rate, etc.), derived (e.g., clustering, predetermined categories), and statistical features (e.g., means, standard deviation, R-squared, etc.).

Model Selection. In embodiments of the invention, the inference model to be trained is a machine learning model such as, for example, a regression model, Support Vector Machines (SVM), Neural Networks, and Recurrent Neural Networks (RNNs) or Transformers (like BERT). In a preferred embodiment, the inference model is a Gradient-Boosted Tree model.

Training the Model. In embodiments, training comprises splitting the data set into training and validation sets. In embodiments, the data set is split into a single training set and a separate validation set. The model is trained using the training set of data and the above-described features and open rates as inputs. The model outputs the predicted score of the subject line. Tuning is performed using the validation set where the following hyperparameters were set: the number of historical campaigns to include in feature computation (e.g., 3, 6, or 12 months of data), which transformer model architecture to compute subject line embeddings (e.g., BERT or GPT), number of trees to use in the model (e.g., 300 to 1000 trees), and the learning rate for the model (e.g., 0.2, 0.3, and 0.5).

In embodiments, the preferred hyperparameters were as follows: Learning rate:
0.2; Number of trees: 1000; Historical campaign data: 3 months; and Transformer model architecture: BERT.

Evaluation. After the model is trained, we evaluate its performance using a metric such as Mean Squared Error (MSE), Mean Absolute Error (MAE), and in preferred embodiments, R-squared value to evaluate the goodness of the fit of the model.

By incorporating the above-described merchant user-specific features, the R-squared value increased from 13% to 30.3%.

Fine-Tuning. In embodiments, after evaluation, the model is optionally adjusted based on evaluation results. For embodiments, the hyperparameters of the model are further adjusted by including more data in the set of historical features used and using more advanced LLM embedding transformer models.

Deployment. In embodiments, the model is deployed for online or live use for evaluating new subject lines. This step can be carried out by deploying the model at server 924. Code versions of the model may be stored in the model library 926 or another location. Optionally, CI/CD implementation is provided to update and deploy the inference model when any changes are made to the offline model 928.

Once deployed, the trained inference model is available to return ranked subject lines as described herein.

### Generating Subject Line Variation For AB Testing

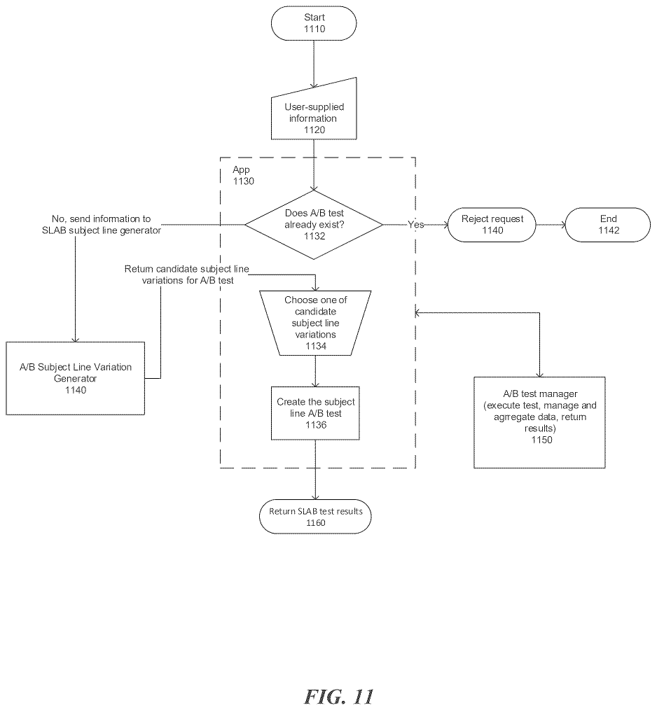

FIG. 11 is a flow chart of a method for creating a subject line variation for AB testing as part of a digital communication management strategy, according to an embodiment of the invention.

Step 1110 is the start of the method.

Step 1120 states prompt for user-supplied information. This step may be performed by a first or front-end server 1130 that is operable to query the user (e.g., merchant user) for a subject line. In embodiments, the method is commenced by a user desiring to test a subject line whether generated by the user or otherwise according to, for example, one of the model-assisted subject line generating embodiments described herein.

In embodiments, step 1120 also prompts the user for a dimension to focus the subject line variation. In embodiments, a graphical user interface displays a field for the user to enter a subject line, and a plurality of buttons for the user to select. Each button directs the subject line variation generation as described herein. Some buttons may open a drop-down menu for the user to select a dimension. Exemplary dimensions include, without limitation, vary personalization, vary question to a statement or vice versa, vary number of emojis, and vary length.

Step 1132 queries whether an AB test already exists. This step is performed for saving time and resources. If an AB test already exists for the received user information, the request is rejected 1140. Optionally, the results of the previous AB test are provided to the user. Optionally, the user is requested for different or alternative information. Rejecting redundant requests saves time and computing resources. This step may also be performed on the front-end server 1130.

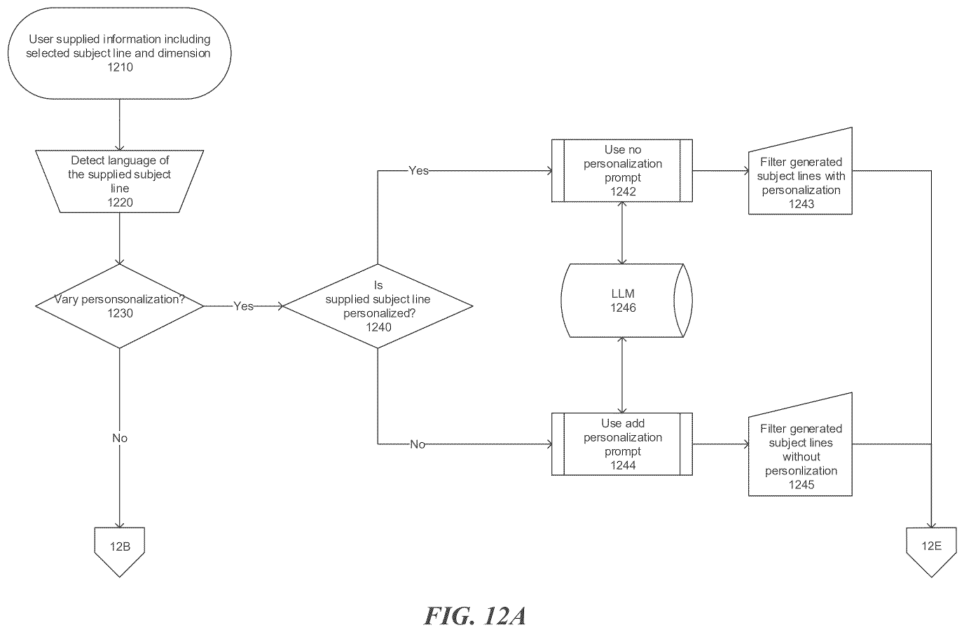

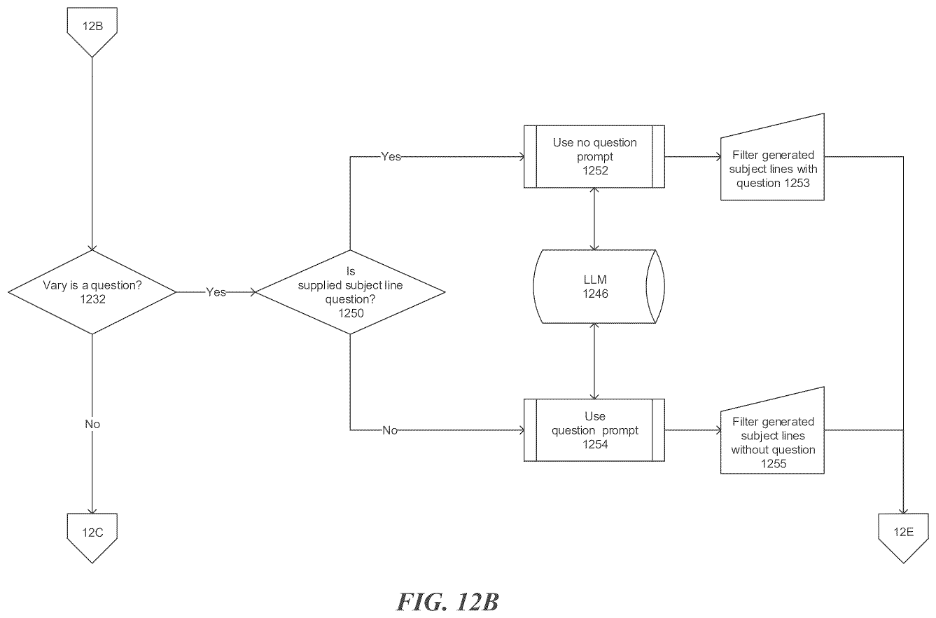

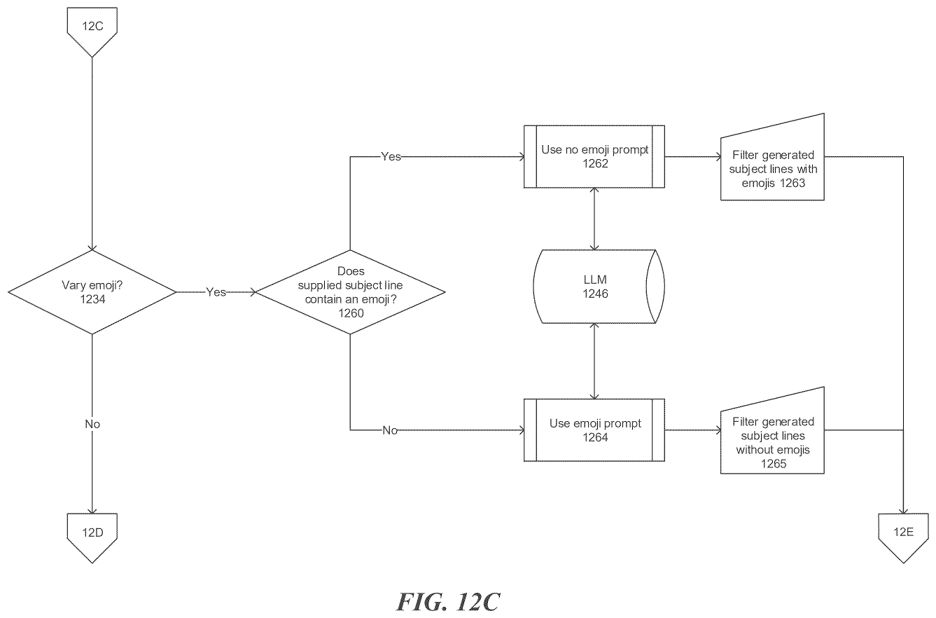

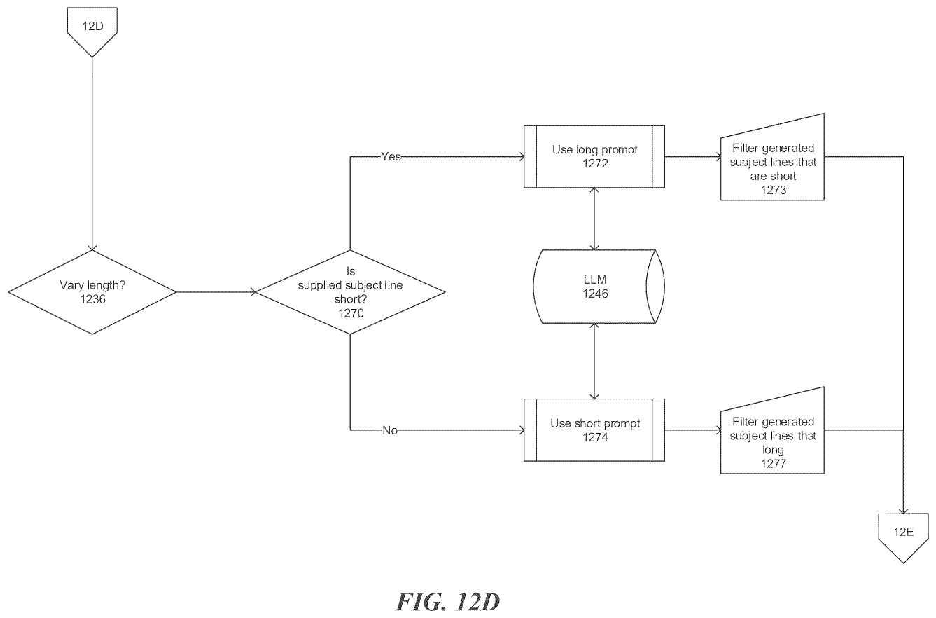

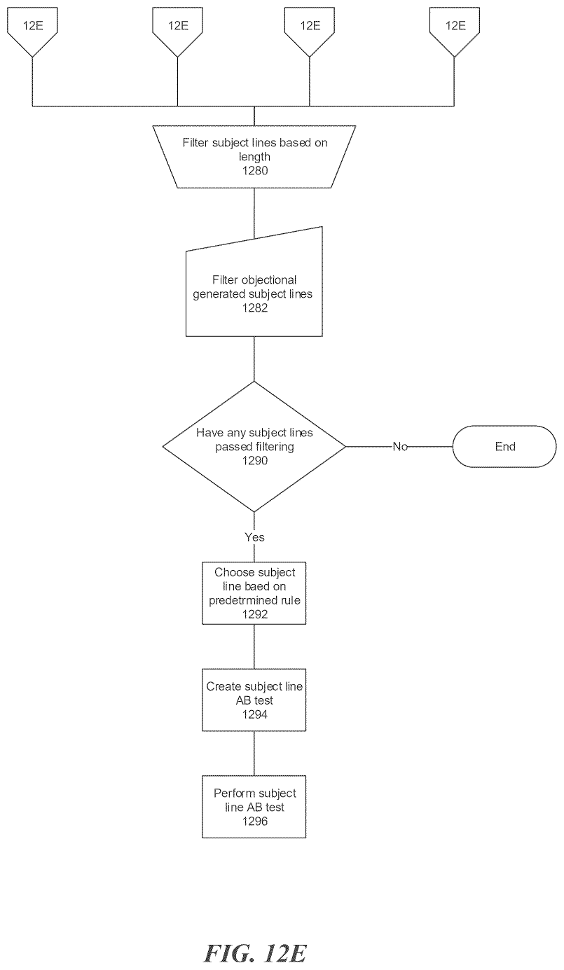

If, however, no previous test exists for the user provided information, the method proceeds to the AB subject line variation generator 1140 to create multiple subject line variations as described in more detail herein with reference to FIGS. 12A-12E. The AB subject line generator 1140 may be implemented on a cloud server platform or service in which it receives the request from step 1132, and returns a plurality of candidate subject line variations to the front-end server 1130.

Optionally, one or more filters are applied to exclude certain subject lines, described herein.

Step 1134 states to choose one of the candidate subject line variations. In embodiments, this step is performed automatically by the front-end server 1130. In embodiments, a list of variations is returned. In embodiments, if there is more than one variation, the first on the list is selected.

In other embodiments, each variation is scored by its conformance to the desired dimension using a ranking model. In embodiments, a ranking model includes mechanistic or robotic rules for determining the score or order of the subject line variations. For example, if an emoji is included, a sentiment analysis is performed to classify the variation (e.g., enthusiastic) with a score.

In another embodiment, for length dimensions, a mechanical rule can be applied to assign a score based on the difference in the number of characters between the user-supplied subject line and the variation.

In another embodiment, a deep learning model is trained and operable to provide a classification score for each returned variation. In embodiments, a regression-type model is trained on a labelled data set (e.g., a variation that highly corresponds to the selected dimensions is labelled with the high score). A production model is produced operable to score each of the variations generated by the LLM. The variation with the highest score is then selected.

In another embodiment, a similarity score (e.g., e.g., 0-1) is computed between the user-supplied subject line and each variation. The variation from the pair resulting in the lowest similarity score is favored for selection.

In a particular embodiment, a combination score is computed and based on the similarity score and the classification score from the deep learning model. For example, if the similarity score is ‘s’and classification score ‘c’, then (1-s)×c or c/s can provide a measure of conformance to the desired dimension and dissimilarity to the user-supplied subject line.

In embodiments, the variations are listed in order from highest to lowest score. In embodiments, the variation with the highest score is chosen/selected. In embodiments, this step is performed by the front-end server.

Step 1136 states to create the subject line AB test. This step is performed by creating an AB test between the user selected subject line and the subject line variation chosen in step 1134, and applying a number of default test parameters. In embodiments, the front-end server 1130 cooperates with a test manager or service 1150 for the default test parameters including managing definitions for the metrics, test size and duration, running the test, analyzing the results and identifying any insights.

Examples of default test parameters for a subject line AB test include, without limitation: sending the AB variations at the same time because different subject lines are being tested and not different send times; using the same email message body for both variations so only the subject line varies; using click rate as the winning metric; and setting the test size to be 100% of recipients. If users do choose to have a less than 100% test size, the default test duration is six hours before a winner is chosen. These default values were selected to balance the strength of the results with the speed required to obtain those results, and feedback from users about their preferences for what the defaults should be. For example, users requested that click rate be used as the default winning metric. These smart test defaults enable first time and casual users to set up a well-designed AB test with only one click.

Recipient (e.g., customer) actions (e.g., open or click-through rates, or products ordered) can be tracked by an ESP 1180 or on-line sales and payment processing platform.

Examples of AB testing implementations for electronic message variations are described in U.S. Pat. No. 11,783,122, filed Jul. 6, 2022, and entitled “Automated Testing of Templates of a Mobile Message”, and US Patent Publication No. 20240281822, filed Feb. 19, 2023, and entitled “Testing of Templates of Electronic Messages”, each of which is incorporated herein by reference in its entirety for all purposes.

Step 1160 states to display the results to the user. In embodiments, the front-end server is configured to display the results including performance metrics for the original subject line and the subject line variation from step 1134. In embodiments, the results are displayed to the user via a GUI.

Additionally, in embodiments of the invention, the user-supplied subject line is replaced by the test variation if an improvement is shown by the testing. Replacement may be automatic or the user may be sent an alert when the test duration and analysis is completed.

In embodiments, the system further comprises a campaign manager server or service 1170 configured to manage digital communication strategies for distributing electronic messages to groups of recipients 1190. For example, a user may create an email campaign for sending an optimized electronic message to recipients 1190. In embodiments, electronic messages are prepared (including the optimized email subject line arising from the AB testing) and sent to the recipients 1190.

In embodiments, electronic messages are prepared using the winning subject line from the AB test.

Optionally, electronic messages are sent in bulk to the recipients 1190 using an email service provider 1180.

Although more typically the user-supplied subject line is manually drafted by the user, in some embodiments, the user-supplied subject line is an AI model-enhanced subject line. In embodiments, a subject line assist platform creates a subject line for the user based on the user input (campaign, user ID, etc.) as described above in connection with FIGS. 1-10. The user then enters this auto-generated subject line into the front-end server 1130 at step 1120 to generate a variation for AB testing.

In some embodiments of the invention, the system is configured to prompt the user whether she desires to (a) draft a subject line from scratch or (b) have a candidate subject line be generated for her. If the latter, the system executes the method described above in connection with, e.g., FIGS. 1-10.

FIGS. 12A-12E collectively depict a more detailed method for creating a subject line variation for AB testing as part of a digital communication management strategy, according to an embodiment of the invention.

Step 1210 states to receive user-supplied information including selected subject line and dimension. The subject line may be entered by the user from scratch or, in some embodiments, the user may request assistance or suggestions for a subject line as described herein with reference to FIGS. 1-10.

The user-supplied information also includes a dimension. Examples of dimensions include personalization, whether there is a question, whether there is an emoji, and length of the subject line. In embodiments, a front-end server (e.g., 1130 of FIG. 11) is operable to prompt the user to select a dimension. In embodiments, a GUI is operable to present one or more buttons for the user to select.

Step 1220 states to detect the language of the supplied subject line. In embodiments, the language detector detects the language of the subject line and translates the language to a language required by the LLM described herein. In embodiments, the language detector detects the language of the subject line and prompts the LLM described herein to generate a subject line in that detected language.

### Personalization Module FIG. 12A

Step 1230 states to query whether to vary personalization. This step is determined based on the dimension specified by the user from step 1210, namely, did the user opt to vary personalization.

If the user did not opt to vary personalization, the method skips the personalization module and proceeds to the next dimension module shown in FIG. 12B, and described herein.

If, however, the user did opt to vary personalization, the method proceeds to step 1240 which states query whether subject line is personalized.

In embodiments, step 1240 is performed by one or more logic rules. For example, in embodiments, when generating personalized subject lines, a shortlist of types of tags are allowed; and personalization is detected using a regular expression looking for a tag pattern e.g., {{tag}}. In some embodiments, personalization is detected by looking for a tag pattern within the subject line.

The prompt passed to the LLM contains a list of potential tags that can be used, and the LLM chooses from this list inferring their meaning from the name of the tag. This list includes: email, first_name, last_name, person.organization, and person.full_name. These tags correspond to properties within a database of recipient attributes such that they can be populated at send time deterministically. The LLM uses one of these tags in an appropriate way within the context of its generated subject line. For example, adding personalization to a subject line “Valentine's messages are coming your way!” could lead to the generation of the subject line “{{first_name}}, get ready for sweet Valentine's messages!”. This generated subject line is personalized with the recipient's first name which is substituted in at send time per recipient. Post-generation validation of a subject line to which personalization has been added filters out any generated subject lines that do not contain one of the tags from the list.

If personalization is detected, the method proceeds to step 1242, which states to use the “no” personalization prompt. A query is then made to the trained large language model (LLM) 1246 based on the supplied subject line and the custom “no” personalization prompt. In embodiments, the prompt includes a tag pattern template, and instructions not to generate subject lines containing such a pattern.

Typically, the prompt includes the first subject line to use as a reference. This is an example of retrieval-augmented generation (RAG) where some important piece of information is included within the prompt rather than relying on a fine-tuned model that has been trained on that information. The prompt also typically includes formatting instructions for the output, as well as instructions about which language to use when generating the subject lines. For embodiments, the language is detected in Step 1220, described above.

The LLM 1246 returns the results including a plurality of AI generated subject lines.

Step 1243 filters out the subject lines that include personalization, namely, removes the subject lines that include personalization. In embodiments, a regular expression is applied to filter out the generated subject line variations containing personalization tags in post-processing. These tags can be any value; and matched on the tag pattern (e.g., double braces).

The method then proceeds to the next phase with reference to FIG. 12E, described herein.

If, however at step 1240, the supplied subject line is not personalized, the method proceeds to step 1244.

Step 1244 states to use “add” personalization prompt. A call is then made to the trained large language model (LLM) 1246 based on the supplied subject line and the custom “add” personalization prompt.

For embodiments, a short list of allowed tags is provided. In embodiments, allowed tags include first name, last name, full name, organization, and email. The LLM is instructed to use one of these tags from the short list of allowed tags.

Based on the supplied subject line and the custom “add” personalization prompt from step 1244, the LLM 1246 returns the results including a plurality of AI generated subject lines.

At step 1245, the subject lines that lack personalization are filtered out, namely, removed. For embodiments, a regular expression is applied to filter out the generated subject line variations not containing personalization using a shortlist of approved tags. The method then proceeds to the next phase with reference to FIG. 12E, described herein.

### Question Module FIG. 12B

Step 1232 states to query whether the user-supplied subject line is a question. This step is determined based on the dimensions specified by the user from step 1210, namely, did the user opt to vary the question to a statement or vice versa.

If the user did not opt to vary the question/statement, the method skips the question module and proceeds to the next dimension module shown in FIG. 12C, and described herein.

If, however, the user did opt to vary the question/statement, the method proceeds to step 1250 which states query whether the subject line is a question.

In embodiments, step 1250 is performed by one or more logic rules. For example, in embodiments, a question is determined by searching for certain punctuation anywhere in the subject line such as a question mark.

If a question is detected, the method proceeds step 1252, which states to use the “no” question prompt. A query is then made to the trained large language model (LLM) 1246 based on the supplied subject line and the custom “no” question prompt. The LLM is instructed not to include questions in the generated subject lines.

The LLM 1246 returns the results including a plurality of AI generated subject lines.

Step 1253 filters out the subject lines that include questions, namely, removes the subject lines that include questions. The method then proceeds to the next phase with reference to FIG. 12E, described herein.

If, however at step 1250, the supplied subject line does not include a question, the method proceeds to step 1254.

Step 1254 states to use question prompt. A call is then made to the trained large language model (LLM) 1246 based on the supplied subject line and the custom “add” question prompt. The LLM is instructed to include questions in the response.

Based on the supplied subject line and the custom “add” question prompt from step 1254, the LLM 1246 returns the results including a plurality of AI generated subject lines. At step 1255, the subject lines that lack questions are filtered out, namely, removed. The method then proceeds to the next phase with reference to FIG. 12E, described herein.

### Emoji Module FIG. 12C

Step 1234 states to query whether the user supplied subject line includes an emoji. This step is determined based on the dimensions specified by the user from step 1210, namely, did the user opt to vary the subject line based on emojis.

If the user did not opt to vary emojis, the method skips the emoji module and proceeds to the next dimension module shown in FIG. 12D, and described herein.

If, however, the user did opt to vary emojis, the method proceeds to step 1260 which states query whether subject line includes an emoji.

In embodiments, step 1260 is performed by one or more logic rules. For example, in embodiments, the presence of an emoji anywhere in the subject line is determined based on a character search of the subject line. For example, the emoji Python package may detect emojis.

If an emoji is detected, the method proceeds step 1262, which states to use the “no” emoji prompt. A query is then made to the trained large language model (LLM) 1246 based on the supplied subject line and the custom “no” emoji prompt. The LLM is instructed to return subject lines without emojis.

The LLM 1246 returns the results including a plurality of AI generated subject lines.

Step 1263 filters out the subject lines that include emojis, namely, removes the subject lines that include emojis. The method then proceeds to the next phase with reference to FIG. 12E, described herein.

If, however at step 1260, the supplied subject line does not include an emoji, the method proceeds to step 1264.

Step 1264 states to use an emoji prompt. A call is then made to the trained large language model (LLM) 1246 based on the supplied subject line and the custom “add” emoji prompt. The LLM is instructed to return subject lines with emojis.

Based on the supplied subject line and the custom “add” emoji prompt from step 1264, the LLM 1246 returns the results including a plurality of AI generated subject lines. At step 1265, the subject lines that lack emojis are filtered out, namely, removed. The method then proceeds to the next phase with reference to FIG. 12E, described herein.

### Length Module FIG. 12D

Step 1236 states to query whether to vary the subject line based on length. This step is determined based on the dimensions specified by the user from step 1210, namely, did the user opt to vary the subject line based on length.

If the user did opt to vary the subject line based on length, the method proceeds to step 1270 which states query whether subject line is short.

In embodiments, step 1270 is performed by one or more logic rules. For example, in embodiments, length is detected by counting characters, and classified as short or long using a limit determined from a study of historical subject lines. In embodiments, short subject lines are 35 or fewer characters, and long subject lines are longer. Historically the median length of an email subject line is 35 characters. In embodiments, a long subject line is required to be 45 characters or longer which introduces some buffer between short and long generated subject lines.

If the supplied subject line is classified as short, the method proceeds step 1272, which states to use the “long” prompt. A query is then made to the trained large language model (LLM) 1246 based on the supplied subject line and the custom “long” prompt.

In embodiments, the length prompt includes explicit instructions to generate a prompt longer than an upper or long threshold. In embodiments, the upper or long threshold is equal to or greater than 45 characters.

The LLM 1246 returns the results including a plurality of AI generated subject lines.

Step 1273 filters out the subject lines that are short, namely, removes the short subject lines. In embodiments, the lower or short threshold is equal to or less than 35 characters.

The method then proceeds to the next phase with reference to FIG. 12E, described herein.

If, however at step 1270, the supplied subject line is not classified as short, the method proceeds to step 1274.

Step 1274 states to use a “short” prompt. A call is then made to the trained large language model (LLM) 1246 based on the supplied subject line and the custom “short” prompt. In embodiments, the length prompt includes explicit instructions to generate a prompt less than a lower or short threshold. In embodiments, the lower or short threshold is equal to or less than 35 characters.

Based on the supplied subject line and the custom “short” prompt from step 1274, the LLM 1246 returns the results including a plurality of AI generated subject lines. At step 1275, the subject lines that are long are filtered out, namely, removed. The method then proceeds to the next phase with reference to FIG. 12E, described herein.

### Subject Line Variations Post Processing FIG. 12E.

With reference to FIG. 12E, step 1280 receives the subject lines from the dimensional modules (FIGS. 12A-12D). Step 1280 filters the subject lines based on length. For example, a predetermined threshold length is applied to filter out any subject lines that are too short or too long. In embodiments, the short or lower threshold length is less than or equal to 35. In embodiments, the upper or long threshold length is equal to or greater than 45. Subject lines that are less than the short threshold or greater than the long threshold are filtered out.

Step 1282 states to filter objectionable generated subject lines. This step may be carried out by a keyword search for any predetermined objectionable words. A predetermined list of objectionable words can include words related to profanity, sex, hate, alcohol, firearms, and tobacco.

Step 1290 queries whether any words have passed filtering. If no generated subject lines pass filtering, the AB test is not created and an error can be reported to the user prompting them to try again with a different subject line or dimension.

However, if one or more subject line variations pass post-processing filtering, the method proceeds to step 1292.

Step 1292 states to choose a subject line based on a predetermined rule. In embodiments, the first listed subject line variation is automatically selected. In embodiments, the listing of subject line variations received from the dimensional modules are provided in a first order which is optimized according to the custom prompt and the trained LLM to return the results in an order from best to worst. Selecting the first choice after filtering thus provides an optimum subject line variation.

Step 1294 states to create the subject line AB test. This is performed based on the generated subject line variation from step 1292 and the originally provided subject line from step 1210 of FIG. 12A. In embodiments, the user can select a button on the GUI to create the subject line AB test. In embodiments, the step calls an AB testing manager (e.g., 1150 of FIG. 11) to generate all the parameters to run a comprehensive AB test including defining the metric, test size and duration.

Step 1296 states to perform the subject line AB test. Step 1296 may be performed by the AB testing manager and can include running the test, analyzing the results and identifying any insights from the results.

Ultimately, after the AB testing is completed, a set of results is provided to the user which compares the performance or success of the user-supplied subject line versus the automatically generated subject line variation.

In embodiments, the results of the AB test are a winning subject line between the user-supplied subject line and the generated subject line variation.

This invention provides significant improvement over previous techniques because of auto-generating a subject line variation for the AB testing and creating an A/B test using default test parameters. Creating a variation of the subject line would normally thwart performing an AB test because of the complexity of AB testing and the lack of sophistication of a typical user. The invention as described above provides electronic message management improvements by providing a new way to generate subject line variations for AB testing, which gives rise to high performing electronic messages.

### Alternative Embodiments

Although specific embodiments have been described and illustrated, the embodiments are not to be limited to the specific forms or arrangements of components and steps so described and illustrated. The described embodiments are to only be limited by the claims.

For example, aspects of the invention are applicable to SMS. SMS messages can be generated and ranked according to the steps described above for subject lines, except the entire SMS message is substituted for the subject line. SMS variations for AB testing can be generated according to the steps described above for subject lines, except the entire SMS message is substituted for the subject line.

Although similar in mechanics, the values for some of the dimensional rules for SMS shall be different than that for subject lines. For example, the length considered short in a SMS shall be different than that for a subject line. Additionally, post processing filtering for length shall apply a different threshold length because a SMS typically is longer than a subject line. In embodiments, the SMS message is considered too long if the number of characters exceeds a maximum SMS length (e.g., 160 characters). In embodiments, the maximum SMS length is region dependent. In embodiments, user supplied information includes the region (or regions) of the recipients. In embodiments, the sub-user or recipient location is tracked or detected (e.g., based on geolocation or IP Address detection), and the SMS threshold is modified based on the anticipated region of the recipient. In embodiments, when multiple regions are detected or anticipated, the maximum SMS length is set based on the region having the lowest maximum SMS threshold before requiring SMS messages to be split.

Additionally, embodiments of the invention can include building an inference model for ranking the subject lines based on historical recipient data instead of the merchant user (namely, sender) data. Indeed, some recipients might tend to engage with “serious” type subject lines (or formal-type) while others may prefer more “silly” content (or friendly-type). In embodiments, a method computes features for the recipient that is receiving the Campaign (what kind of subject lines have they responded to in the past, what subject lines have they not engaged with, etc.) to recommend personalized subject lines based on the set of recipients of the marketing content.

Additionally, embodiments of the invention can include a wide variety of different dimensions for generating SMS or subject line variations for AB testing. For example, another exemplary dimension can include formal versus friendly, where the user opts to vary this dimension and an inference model (optionally a trained machine learning model) is operable to detect whether the user supplied SMS or subject line is formal or friendly, or serious or silly, respectively. The method can then proceed similarly to the steps set forth in one of the sub-processes described in FIGS. 12B-12E.

Additionally, another exemplary dimension can include SMS versus MMS, where the user opts to vary this dimension. In embodiments, if the user supplied message is an MMS message with images, then the generated message would be a text-only SMS message. This dimension is analogous to varying whether a message body contains an image or not, and in its application removes an image from a message body that contains the image, and potentially rewrites the accompanying text to accommodate that removal.

Additionally, embodiments of the invention can include predicting scores and ranking and providing, not only subject line content, but other types of content. Examples of other types of content include, without limitation, text, images, links, and formatting. Indeed, the steps described herein can be utilized to predict the quality of various types of campaign content, customized for the specific merchant (or company) based on its historical data.

Additionally, in embodiments, where a discriminator model is applied to rank multiple candidate subject lines (e.g., the second discriminator model 550/372 of FIG. 5), the subject line variation for testing can be generated according to the process set forth in FIGS. 11-12 where the dimensional information is received from the user when the user provides the initial campaign information (e.g., step 110 of FIG. 3, or step 510 of FIG. 5).

What is claimed:

1. A computer-implemented method of generating subject line variations for AB testing for digital communication comprises:
receiving, on a first server, a user-supplied subject line via a GUI;
presenting to the user via the GUI a plurality of dimensions for varying a characteristic of the subject line;
receiving, on the first server, a user-selected dimension from the plurality of dimensions;
sending the user-supplied subject line and the user-selected dimension to a subject line variation generator;
applying, by the subject line variation generator, a logic rule to the subject line based on the user-selected dimension, wherein the logic rule comprises:
querying whether the user-supplied subject line is characterized by the user-selected dimension; and
generating a dimension-customized LLM prompt based on whether the user-supplied subject line is characterized by the user-selected dimension;
sending, to an LLM, the user-supplied subject line and the dimension-customized LLM prompt;
receiving from the LLM at least one subject line variation;
choosing the subject line variation; and
displaying the subject line variation to the user.

2. The method of claim 1, further comprising applying, between the steps of receiving the at least one subject line variation and prior to the choosing step, a first post-processing filter operable to determine the number of characters in each of the subject line variations and to remove subject line variations that have a character count exceeding a maximum threshold.

3. The method of claim 1, further comprising applying, between the steps of receiving the at least one subject line variation and prior to the choosing step, a second post-processing filter operable to search for offending terms and to remove subject line variations that have said offending terms, wherein the offending terms are predetermined and stored in an electronic file.

4. The method of claim 1, wherein the user selected dimension is to vary the subject line by personalization, and the querying step is performed by evaluating the type of tag assigned to the user-supplied subject line when the user-supplied subject line was created.

5. The method of claim 1, wherein the user selected dimension is to vary the subject line by emojis, and the querying step is performed by evaluating the user-supplied subject line for the presence of emojis.

6. The method of claim 1, wherein the user selected dimension is to vary the subject line between a statement and a question, and the querying step is performed by evaluating the user-supplied subject line for punctuation.

7. The method of claim 1, wherein the user selected dimension is to vary the subject line length, and the querying step is performed by evaluating the user-supplied subject line by the number of characters.

8. The method of claim 1, further comprising a creating and running the AB test between the user-supplied subject line, the chosen subject line variation, and a set of default test parameters, and wherein the AB test comprises tracking customer actions, and wherein the default test parameters include at least test duration and test size.

9. The method of claim 8, wherein the customer actions tracked include average open rate, average click rate, or product ordered.

10. The method of claim 9, further comprising generating an email comprising a winning subject line arising from the AB test, and sending the email to at least one recipient.

11. A computer-implemented method of generating short text variations for AB testing for digital communication comprises:
receiving, on a first server, a user-supplied short text via a GUI;
presenting to the user via the GUI a plurality of dimensions for varying a characteristic of the short text;
receiving, on the first server, a user-selected dimension from the plurality of dimensions;
sending the user-supplied short text and the user-selected dimension to a short text variation generator;
applying, by the short text variation generator, a logic rule to the short text based on the user-selected dimension, wherein the logic rule comprises:
querying whether the user-supplied short text is characterized by the user-selected dimension; and
generating a dimension-customized LLM prompt based on whether the user-supplied short text is characterized by the user-selected dimension;
sending, to a LLM, the user-supplied short text and the dimension-customized LLM prompt;
receiving from the LLM at least one short text variation;
choosing the short text variation; and
displaying the short text variation to the user.

12. The method of claim 11, wherein the short text is one of an SMS and a subject line.

13. The method of claim 12, wherein the user selected dimension is one selected from varying whether the short text (a) comprises personalization, (b) comprises a question, (c) is less than a threshold length, and (d) comprises at least one emoji.

14. The method of claim 13, further comprising a creating the AB test based on the chosen short text variation, the user-supplied short text, and a set of default test parameters.

15. The method of claim 14, further comprising running the AB test, wherein the AB test comprises tracking customer actions.

16. The method of claim 15, further comprising generating a SMS comprising a winning short text, and sending the SMS to at least one recipient.

17. A system for generating short texts for electronic messages for digital communication
for a user, the system comprising:
a front-end server programmed and operable to:
receive a user-supplied short text;
present to the user a plurality of dimensions for varying a characteristic of the short text;
receive a user-selected dimension from the plurality of dimensions;
send the user-supplied short text and the user-selected dimension to a AB short text variation generator;
choose the short text variation from candidate short text variations returned by the AB short text variation generator;
display the chosen short text variation; and wherein the system further comprises:
a AB short text variation generator in electronic communication with the front-end server through a network, the AB short text variation generator programmed and operable to:
apply a logic rule to the user-supplied short text based on the user-selected dimension, wherein the logic rule comprises:
querying whether the user-supplied short text is characterized by the user-selected dimension; and
generating a dimension-customized LLM prompt based on whether the user-supplied short text is characterized by the user-selected dimension;
send, to an LLM, the user-supplied short text and the dimension-customized LLM prompt;
receive from the LLM the candidate short text variations; and
return to the front-end server the short text variations.

18. The system of claim 17, wherein the presented plurality of dimensions comprise at least one of: (a) varying whether the short text comprises personalization, (b) varying whether the short text comprises a question, (c) whether the short text is less than a threshold length, and (d) varying whether the short text comprises at least one emoji.

19. The system of claim 18, further comprising an AB test manager server operable to create and run the AB test, and wherein the AB test manager is operable to track actions of the recipient of the electronic messages.

20. The system of claim 19, further comprising an ESP operable to generate bulk electronic messages comprising a winning short text arising from the AB test, and send the bulk electronic messages to the recipients.
